(19) United States
(12) Patent Application Publication
(10) Pub. No.: US 2024/0019864 A1
(43) Pub. Date: Jan. 18, 2024

(54) VEHICLE ASSIST DRONE

(71) Applicant: GM Cruise Holdings LLC, San Francisco, CA (US)

(72) Inventor: Mohamed Mostafa Elshenawy, Burlingame, CA (US)

(73) Assignee: GM Cruise Holdings LLC, San Francisco, CA (US)

(21) Appl. No.: 17/864,734

(22) Filed: Jul. 14, 2022

(51) Int. Cl. G05D 1/00; B64C 39/02

(52) U.S. Cl. CPC G05D 1/0088; B64C 39/024; B64C 2201/027; B64C 2201/123; B64C 2201/208; B64C 2201/141; G05D 2201/0213

(57) ABSTRACT

Particular embodiments described herein provide for a vehicle assist drone. The vehicle assist drone can be operated in different modes. For example, the vehicle assist drone can be deployed in a user of an AV service assist mode, a clear occlusion mode, refined routing mode, a security mode, a search and rescue mode (e.g., search for missing child mode), or some other mode. In addition, the vehicle assist drone can be used to supplement a vehicle's sensors. For example, supplementary sensor data from the vehicle assist drone can be used in place of the vehicle's sensors or combined with sensor data from the onboard sensors of the vehicle to supplement the vehicle's sensors.

### TECHNICAL FIELD OF THE DISCLOSURE

The present disclosure relates generally to a vehicle and, more specifically, to a vehicle assist drone.

### BACKGROUND

An autonomous vehicle (AV) is a vehicle that is capable of sensing and navigating its environment with little or no user input. The AV may sense its environment using sensing devices such as radio detection and ranging (RADAR), light detection and ranging (LIDAR), image sensors, cameras, and the like. An AV system may also use information from a global positioning system (GPS), navigation systems, vehicle-to-vehicle communication, vehicle-to-infrastructure technology, and/or drive-by-wire systems to navigate the vehicle. As used herein, the phrase “autonomous vehicle” includes both fully autonomous and semi-autonomous vehicles.

### BRIEF DESCRIPTION OF THE DRAWINGS

To provide a more complete understanding of the present disclosure and features and advantages thereof, reference is made to the following description, taken in conjunction with the accompanying FIGURES, wherein like reference numerals represent like parts, in which:

FIGS. 1A and 1B show an autonomous vehicle environment according to some embodiments of the present disclosure;

FIG. 2 is a block diagram illustrating a drone according to some embodiments of the present disclosure;

FIG. 3 is a block diagram illustrating examples details of a drone according to some embodiments of the present disclosure;

FIG. 4 illustrates an onboard controller of a drone according to some embodiments of the present disclosure;

FIG. 5 illustrates an onboard controller of an autonomous according to some embodiments of the present disclosure;

FIG. 6 illustrates an example system summary according to some embodiments of the present disclosure;

FIG. 7 illustrates an example system summary according to some embodiments of the present disclosure;

FIGS. 8A and 8B illustrate an example system summary according to some embodiments of the present disclosure;

FIG. 9 illustrates an example system summary according to some embodiments of the present disclosure;

FIG. 10 illustrates an example system summary according to some embodiments of the present disclosure;

FIG. 11 illustrates an example system summary according to some embodiments of the present disclosure;

FIG. 12 illustrates an example system summary according to some embodiments of the present disclosure;

FIG. 13 illustrates an example system summary according to some embodiments of the present disclosure;

FIG. 14 illustrates an example system summary according to some embodiments of the present disclosure;

FIG. 15 is a block diagram illustrating an example drone according to some embodiments of the present disclosure;

FIGS. 16A and 16B are a block diagram illustrating an example drone according to some embodiments of the present disclosure;

FIG. 17 is a flowchart showing a process for using a vehicle assist drone according to some embodiments of the present disclosure;

FIG. 18 is a flowchart showing a process for using a vehicle assist drone according to some embodiments of the present disclosure;

FIG. 19 is a flowchart showing a process for using a vehicle assist drone according to some embodiments of the present disclosure;

FIG. 20 is a flowchart showing a process for using a vehicle assist drone according to some embodiments of the present disclosure;

FIG. 21 is a flowchart showing a process for using a vehicle assist drone according to some embodiments of the present disclosure

FIG. 22 shows an autonomous vehicle environment according to some embodiments of the present disclosure; and

FIG. 23 is a block diagram illustrating a fleet management system according to some embodiments of the present disclosure.

The FIGURES of the drawings are not necessarily drawn to scale, as their dimensions can be varied considerably without departing from the scope of the present disclosure.

### DESCRIPTION OF EXAMPLE EMBODIMENTS OF THE DISCLOSURE

Overview

The demand for autonomous vehicle (AV) services (e.g., ride hail and rideshare services) has been rising. However, many services cannot meet the rising demand due to high cost and technical challenges. For example, an AV can be relatively expensive and requires a complex system of sensors to allow the AV to safely navigate in the environment. Therefore, improved technology for autonomous vehicles is needed.

An AV assist drone can help to overcome some of these problems. More specifically, the system can allow the AV to use the resources of an AV assist drone to supplement the AV's sensors. For example, supplementary sensor data from the AV assist drone can be used in place of the AV's sensors or combined with sensor data from the onboard sensors of the AV to supplement the AV's sensors.

In a specific example, the AV assist drone can be operated in different modes. For example, the AV assist drone can be deployed in a user of an AV service assist mode, a clear occlusion mode, refined routing mode, a security mode, a search and rescue mode (e.g., search for missing child mode), or some other mode. As used herein, the term “deploy” and its derivatives (e.g., deployed, deploying, etc.) incudes to bring into effective action.

When the AV assist drone is deployed in the user of an AV service assist mode, the AV is part of an AV service and the AV assist drone can provide assistance and guidance to the user to help guide the user from a user pickup location to the AV and from the AV to a drop off location. In a specific example, the AV assist drone may use an indicator that helps guide the user in a direction that the user needs to travel to the AV. In another specific example, the AV assist drone may use lighting that provides security to the user and/or helps the user see the environment in a dark area or area that is not well lit. In a further specific example, the AV assist drone may guide a user to and from an AV for pickup and/or drop off of a delivery.

When the AV assist drone is deployed in the clear occlusion mode, the AV assist drone can help supplement the sensors on the AV to allow the AV to identify objects, or a lack of objects, in areas that are occluded or areas that are blind to the sensors on the AV. The AV assist drone can use one or more sensors on the AV assist drone to help supplement the sensors on the AV to allow the AV to identify objects, or a lack of objects, in areas that are occluded or areas that are blind to the sensors on the AV. In some examples, the AV specifically instructs the AV assist drone regarding the location of the occlusion and instructs the AV assist drone to navigate a specific way to help the AV fill in the occlusions. In other examples, the AV deploys the AV assist drone to review a route the AV is current following. The AV assist drone can autonomously, without specific instructions from the AV, determine areas along the route that are occluded or will be occluded and deploy to a location to fill in the occlusion. In some examples, the AV sends a model of the environment around the AV and the AV assist drone can autonomously navigate in such a way to fill in the occlusions for the AV so the AV does not need to do any route planning for the AV assist drone.

When the AV assist drone is deployed in the refined routing mode, the AV assist drone can act as a real time eye that provides a view of an upcoming route. Current route planning applications and routing applications always have a time delay and take a period of time to detect congestion, a wreck, or some obstacle blocking the route of the AV. The AV assist drone can act as an eye in the sky to detect a just occurring obstruction (e.g., a double-parked car, a traffic jam, etc.). When an obstacle is detected that will block the route of the AV, a new route can be determined for the AV that avoids the detected obstacle.

When the AV assist drone is deployed in the security mode, the AV assist drone can cover an area of patrol in a methodical manner. The patrol of the AV assist drone can be fully customized so the patrol of an area is random and covers the area completely, the patrol can have a heavier weight on patrolling the perimeter of an area, or the patrol can focus on a specific area or areas. If suspicious activity is detected by the AV assist drone during the patrol, the police or security force could be alerted about the suspicious activity. For example, the AV assist drone can recognize an open door or window or car glass shattered and immediately alert the police.

In the search and rescue mode, the AV assist drone can cover an area of patrol in a methodical manner and identify a specific person or object. For example, in the case of a missing child, the AV assist drone may use facial recognition to search a crowd of people for the missing child or the AV assist drone may use object recognition to search for a specific vehicle or license plate.

In an example, the AV assist drone is fully autonomous and performs functions without help or guidance from the AV. In other examples, the AV assist drone is partially autonomous and can receive instructions or requests (e.g., help a passenger navigate to the AV, determine a clear path around an obstruction in front of the AV, etc.) from the AV but the AV assist drone is able to determine how to fulfill the instructions or requests from the AV. In yet other examples, the AV assist drone is controlled by the AV and the AV has complete control of the functions of the AV assist drone.

Embodiments of the present disclosure provide a method for guiding a user of an AV service to a vehicle associated with the AV service. The method can include identifying a location of the user of the AV service, deploying a vehicle assist drone to the location of the user, and using the vehicle assist drone, providing an indicator to guide to the user of the AV service to the vehicle. The indicator can be an arrow, a line, a sound, or some other type of indicator. In some examples, the vehicle includes a vehicle assist drone housing that can recharge a battery in the vehicle assist drone when the vehicle assist drone is coupled to the vehicle assist drone housing. The vehicle assist drone can authenticate the user using facial recognition, through communication with a user device associated with the user, or may not authenticate the user. The vehicle assist drone can be an aerial drone, a terrestrial drone, or a hybrid aerial/terrestrial drone. In some examples, the vehicle assist drone is an autonomous drone that navigates without navigation instructions from the vehicle. In other examples, the vehicle assist drone is a semi-autonomous drone or the vehicle has complete control of the vehicle assist drone.

In addition, a method for clearing one or more occlusions in an environment around a vehicle can include deploying a vehicle assist drone from the vehicle, where the vehicle assist drone includes one or more sensors and is in communication with the vehicle, using the one or more sensors on the vehicle assist drone to collect sensor data related to the environment around the vehicle, and communicating the collected sensor data to the vehicle from the vehicle assist drone, where the collected sensor data is used to clear one or more occlusions in the environment around the vehicle. The one or more sensors can include a camera, LIDAR, a time-of-flight sensor, and other sensors. In some examples, the vehicle communicates a location of the one or more occlusions to the vehicle assist drone. Also, the vehicle can control navigation and sensor data collection of the vehicle assist drone. In some examples, the vehicle assist drone is an autonomous drone.

Also, a method for refining a route of a vehicle can include deploying a vehicle assist drone from the vehicle, where the vehicle assist drone includes one or more sensors, using the one or more sensors on the vehicle assist drone to collect sensor data related to the route of the vehicle, and communicating the collected sensor data to the vehicle from the vehicle assist drone, where the collected sensor data is used to identify one or more obstructions along the route. In some examples, a new route for the vehicle is created based on identified one or more obstructions along the route. The identified one or more obstructions can include a traffic jam, a vehicle accident that has occurred along the route, or some other obstruction that can block the route of the vehicle.

The vehicle assist drone can include a sensor suite that includes one or more sensors to sense an environment and generate sensor data. The vehicle assist drone can also include a perception system to receive the sensor data and to acquire map data. The map data and the sensor data can be used to generate vehicle assist drone real world environment data. The vehicle assist drone can also include a vehicle interface module to communicate with the vehicle. The vehicle assist drone can also include a user guidance module to provide an indicator to guide to a user of a AV service to the vehicle.

As will be appreciated by one skilled in the art, aspects of the present disclosure, in particular aspects of the AV assist drone, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as an “engine,” a “circuit,” a “module,” or a “system.” Functions described in this disclosure may be implemented as an algorithm executed by one or more hardware processing units (e.g., one or more microprocessors) of one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied (e.g., stored) thereon. In various embodiments, such a computer program may, for example, be downloaded (updated) to the existing devices and systems (e.g., to the existing perception system devices or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing or a subset of the elements illustrated in a drawing. Further, some embodiments can incorporate any suitable combination of features from two or more drawings. Other features and advantages of the disclosure will be apparent from the following description and the claims.

The following disclosure describes various illustrative embodiments and examples for implementing the features and functionality of the present disclosure. While particular components, arrangements, or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, or legal constraints, which may vary from one implementation to another. Moreover, it will be appreciated that, while such a development effort might be complex and time-consuming, it would nevertheless be a routine undertaking for those of ordinary skill in the art having the benefit of this disclosure.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, or conditions, the phrase “between X and Y” represents a range that includes X and Y. The terms “substantially,” “close,” “approximately,” “near,” and “about,” generally refer to being within +/−20% of a target value (e.g., about 10 meters includes between 8 meters and 12 meters and/or within +/−5 or 10% of a target value) based on the context of a particular value as described herein or as known in the art. In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or system.

In the following detailed description, reference is made to the accompanying drawings that form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). Reference to “one embodiment” or “an embodiment” in the present disclosure means that a particular feature, structure, or characteristic described in connection with the embodiment is included in at least one embodiment. The appearances of the phrase “in one embodiment” or “in an embodiment” are not necessarily all referring to the same embodiment. The appearances of the phrase “for example,” “in an example,” or “in some examples” are not necessarily all referring to the same example.

The systems, methods and devices of this disclosure each have several innovative aspects, no single one of which is solely responsible for all of the desirable attributes disclosed herein. Details of one or more implementations of the subject matter described in this Specification are set forth in the description below and the accompanying drawings. As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

It is to be understood that other embodiments may be utilized and structural changes may be made without departing from the scope of the present disclosure. Substantial flexibility is provided by an electronic device in that any suitable arrangements and configurations may be provided without departing from the teachings of the present disclosure.

As used herein, the term “when” may be used to indicate the temporal nature of an event. For example, the phrase “event ‘A’ occurs when event ‘B’ occurs” is to be interpreted to mean that event A may occur before, during, or after the occurrence of event B, but is nonetheless associated with the occurrence of event B. For example, event A occurs when event B occurs if event A occurs in response to the occurrence of event B or in response to a signal indicating that event B has occurred, is occurring, or will occur.

Example Autonomous Vehicle System

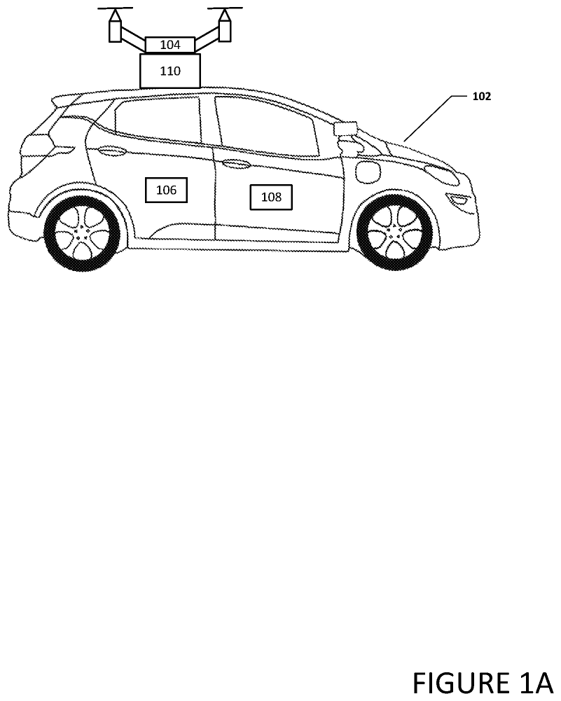

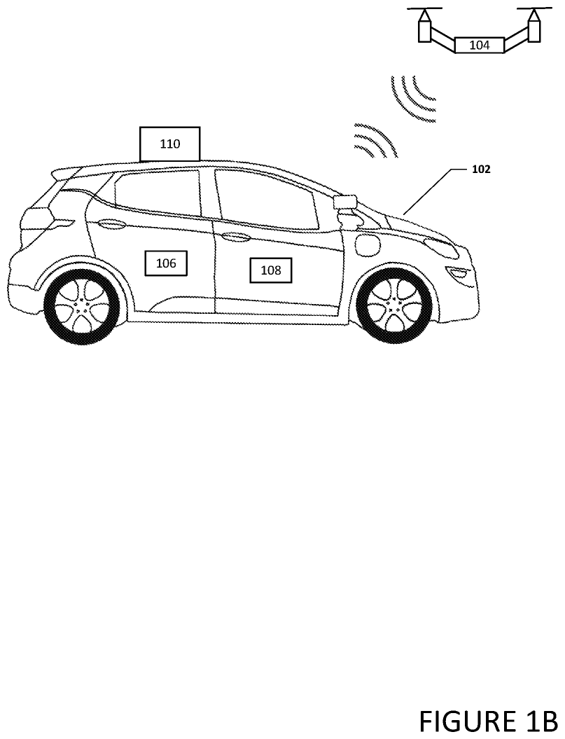

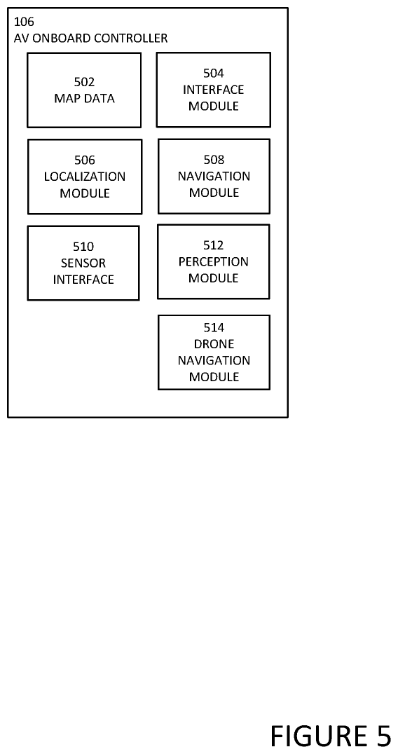

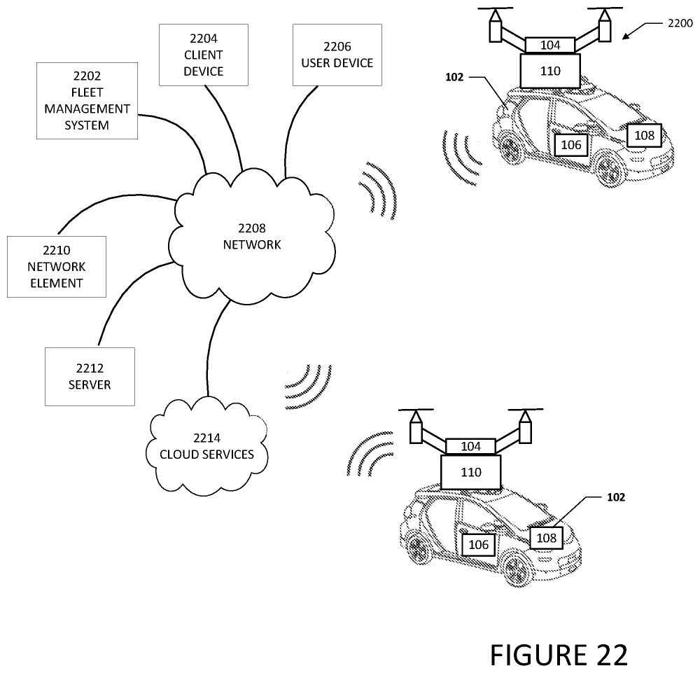

FIGS. 1A and 1B show a portion of an AV environment 2200 according to some embodiments of the present disclosure. The AV environment 2200 is described in more detail in FIG. 22 below. The AV environment 2200 can include AV 102 and an AV assist drone 104. In an example, the AV assist drone 104 is fully autonomous and performs functions without help or guidance from the AV 102. In other examples, the AV assist drone 104 is partially autonomous and can receive instructions or requests (e.g., help a passenger navigate to the AV 102, determine a clear path around an obstruction in front of the AV 102, etc.) from the AV 102 and the AV assist drone 104 is able to determine how to fulfill the instructions or requests from the AV 102. In yet other examples, the AV assist drone 104 is controlled by the AV 102 and the AV 102 has complete control of the functions of the AV assist drone 104.

[OM] The AV 102 can include an AV onboard controller 106, an AV sensor suite 108, and an AV assist drone housing 110. The AV onboard controller 106 controls the AV 102 and helps facilitate communication with the AV 102. The AV onboard controller 106 is described in more detail in FIG. 5 and below. The AV sensor suite 108 detects the environment inside and outside of the AV 102 and generates sensor data describing the environment surrounding the AV 102. In some examples, the AV assist drone housing 110 is a landing pad for the AV assist drone 104. The AV assist drone housing 110 provides a landing area for the AV assist drone 104 and can secure the AV assist drone 104 to the AV 102 when the AV assist drone 104 is not airborne and deployed. In addition, the AV assist drone housing 110 can recharge a battery on the AV assist drone 104. While FIGS. 1A and 1B illustrate a specific size, shape, and location of the AV assist drone housing 110, the size, shape, location, and other features of the AV assist drone housing 110 depend on design choice and design constraints. More specifically, the location of the AV assist drone housing 110 may be on a trunk portion of the AV 102 if the roof of the AV 102 has limited space.

As illustrated in FIG. 1B, the AV assist drone 104 can deploy from the AV assist drone housing 110 and travel away from the AV 102 under its own power. When the AV assist drone 104 is away from the AV 102, the AV assist drone 104 can wirelessly communicate with the AV 102 to engage in auxiliary activities around the AV. The AV assist drone 104 can be deployed in a user of an AV service assist mode, a clear occlusion mode, a refined routing mode, a security mode, a search and rescue mode (e.g., search for missing person mode), or some other mode.

When the AV assist drone 104 is deployed in the user of an AV service assist mode, the AV 102 is part of an AV service the AV assist drone 104 can provide guidance to the user of the of an AV service. For example, the AV assist drone 104 can help guide the user of the AV service from a user pickup location to the AV 102 and from the AV 102 to a drop off location. In a specific example, the AV assist drone 104 may use a laser pointer that points in a direction that the user needs to travel to help guide the user of the AV service to the AV 102. In another specific example, the AV assist drone 104 may use lighting that provides security to the user and/or helps the user see the environment in a dark area or area that is not well lit. In yet another example, the AV assist drone 104 may use a live feed audio and/or video that connects the user to remote assistance if needed to provide the user with increased security.

When the AV assist drone 104 is deployed in the clear occlusion mode, the AV assist drone 104 can help supplement the sensors on the AV 102 to allow the AV 102 to identify objects, or a lack of objects, in areas that are occluded or areas that are blind to the sensors on the AV 102. In a specific example, the AV 102 can send a model of the environment around the AV 102. The model of the environment around the AV 102 can include what areas are occluded in the environment around the AV 102 and what areas are not occluded in the environment around the AV 102. The AV assist drone 104 can use one or more sensors on the AV assist drone 104 to help supplement the sensors on the AV 102 to allow the AV 102 to identify objects, or a lack of objects, in areas that are occluded or areas that are blind to the sensors on the AV 102. In some examples, the AV 102 specifically instructs the AV assist drone 104 regarding the location of the occlusion and instructions the AV assist drone 104 to navigate a specific way to help the AV 102 fill in the occlusions. The AV assist drone 104 can deploy to a location to fill in the occlusions (e.g., peak around a corner, determine what is past double-parked cars, etc.). In other examples, the AV 102 sends the AV assist drone 104 to review a route the AV 102 is current following. The AV assist drone 104 can autonomously, without specific instructions from the AV 102, determine areas along the route that are occluded or will be occluded and deploy to a location to fill in the occlusion. In some examples, the AV 102 sends a model of the environment around the AV 102 and the AV assist drone 104 can autonomously navigate in such a way to fill in the occlusions for the AV 102 so the AV 102 does not need to determine route planning for the AV assist drone 104.

When the AV assist drone 104 is deployed in the refined routing mode, the AV assist drone 104 can act as a real time eye that provides a view of an upcoming route of the AV 102. Current route planning applications and routing applications always have a time delay and take a period of time to detect congestion or a wreck or some obstacle blocking the route of the AV 102. The AV assist drone 104 can act as an eye in the sky to detect a just occurring obstruction (e.g., a double-parked car, a traffic jam, etc.).

When the AV assist drone 104 is deployed in the security mode, the AV assist drone 104 can cover an area of patrol in a methodical manner. The patrol of the AV assist drone 104 can be fully customized so the patrol is random and covers an area completely or the patrol can put a heavier weight on patrolling the permitter of an area or a specific area. The patrol of the AV assist drone 104 can cover an area or each street in an area in a methodical way (e.g., the AV assist drone 104 can patrol a specific area or even a specific house a preset number of time (e.g., ten times) a night at certain times or random times). In addition, data from the AV assist drone 104 can be anonymized. If suspicious activity is detected by the AV assist drone 104, the police or security force could be alerted about the suspicious activity. For example, the AV assist drone 104 can recognize an open door or window or car glass shattered and immediately alert the police.

When the AV assist drone 104 is deployed in the search and rescue mode, the AV assist drone 104 can cover an area in a methodical manner and identify a specific person or object. For example, in the case of a missing child, the AV assist drone 104 may use facial recognition to search a crowd of people for the missing child or the AV assist drone 104 may use object recognition to search for a specific vehicle or license plate.

The AV 102 is a vehicle that is capable of sensing and navigating its environment with little or no user input. The AV 102 may be a semi-autonomous or fully autonomous vehicle (e.g., a boat, an unmanned aerial vehicle, a driverless car, etc.). Additionally, or alternatively, the AV 102 may be a vehicle that switches between a semi-autonomous state and a fully autonomous state and thus, the AV may have attributes of both a semi-autonomous vehicle and a fully autonomous vehicle depending on the state of the vehicle. The AV 102 may include a throttle interface that controls an engine throttle, motor speed (e.g., rotational speed of electric motor), or any other movement-enabling mechanism, a brake interface that controls brakes of the AV (or any other movement-retarding mechanism), and a steering interface that controls steering of the AV (e.g., by changing the angle of wheels of the AV). The AV 102 may additionally or alternatively include interfaces for control of other vehicle functions (e.g., windshield wipers, headlights, turn indicators, air conditioning, etc.).

The AV onboard controller 106 controls operations and functionality of the AV 102. In some embodiments, the AV onboard controller 106 is a general-purpose computer, but may additionally or alternatively be any suitable computing device. The AV onboard controller 106 is adapted for input/output (I/O) communication with other components of the AV 102 (e.g., the AV sensor suite 108, an UI module of the AV, etc.) and external systems (e.g., the fleet management system 2202 illustrated in FIG. 22). The AV onboard controller 106 may be connected to the Internet via a wireless connection (e.g., via a cellular data connection). Additionally, or alternatively, the AV onboard controller 106 may be coupled to any number of wireless or wired communication systems.

The AV onboard controller 106 processes sensor data generated by the AV sensor suite 108 and/or other data (e.g., data received from the AV assist drone 104, from the fleet management system 2202, etc.) to determine the state of the AV 102. Based upon the vehicle state and programmed instructions, the AV onboard controller 106 modifies or controls behavior of the AV 102. In some embodiments, the AV onboard controller 106 implements an autonomous driving system (ADS) for controlling the AV 102 and processing sensor data from the AV sensor suite 108 and/or other sensors in order to determine the state of the AV 102. Based upon the vehicle state and programmed instructions, the AV onboard controller 106 modifies or controls driving behavior of the AV 102.

The AV sensor suite 108 can include a computer vision (“CV”) system, localization sensors, and driving sensors. For example, the AV sensor suite 108 may include interior and exterior cameras, radar sensors, sonar sensors, light detection and ranging (LIDAR) sensors, thermal sensors, wheel speed sensors, inertial measurement units (IMUS), accelerometers, microphones, strain gauges, pressure monitors, barometers, thermometers, altimeters, ambient light sensors, etc. The sensors may be located in various positions in and around the AV 102. For example, the AV 102 may have multiple cameras located at different positions around the exterior and/or interior of the AV 102.

The AV 102 may also include a rechargeable battery that powers the AV 102. The battery may be a lithium-ion battery, a lithium polymer battery, a lead-acid battery, a nickel-metal hydride battery, a sodium nickel chloride (“zebra”) battery, a lithium-titanate battery, or another type of rechargeable battery. In some embodiments, the AV 102 is a hybrid electric vehicle that also includes an internal combustion engine for powering the AV 102 (e.g., when the battery has low charge). In some embodiments, the AV 102 includes multiple batteries. For example, the AV 102 can include a first battery used to power vehicle propulsion, and a second battery used to power the AV onboard controller 106 and/or AV hardware (e.g., the AV sensor suite 108 and the AV onboard controller 106). The AV 102 may further include components for charging the battery (e.g., a charge port configured to make an electrical connection between the battery and a charging station).

Example Drone

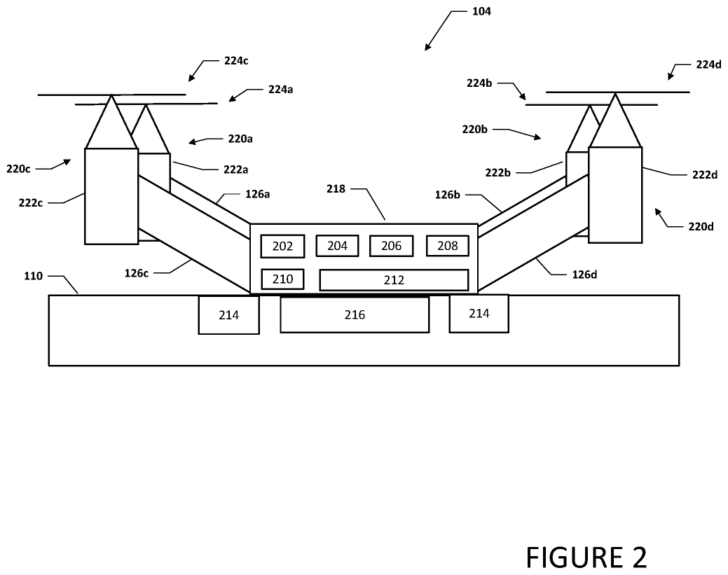

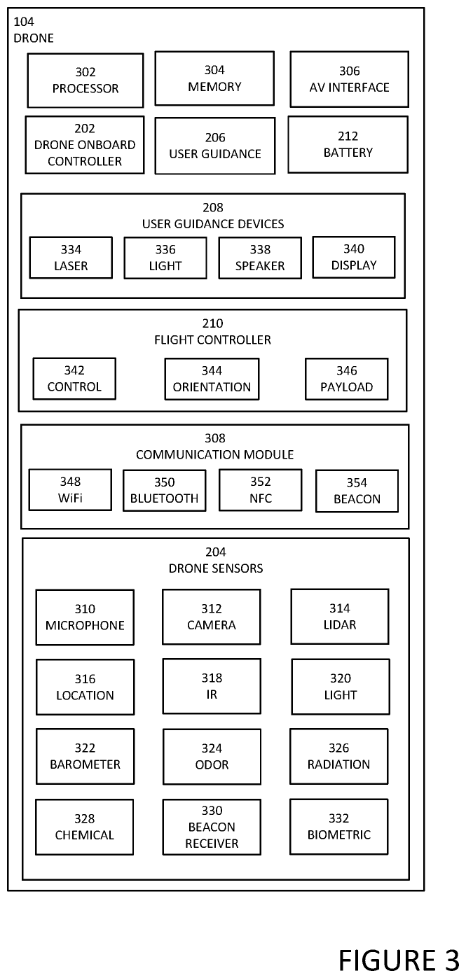

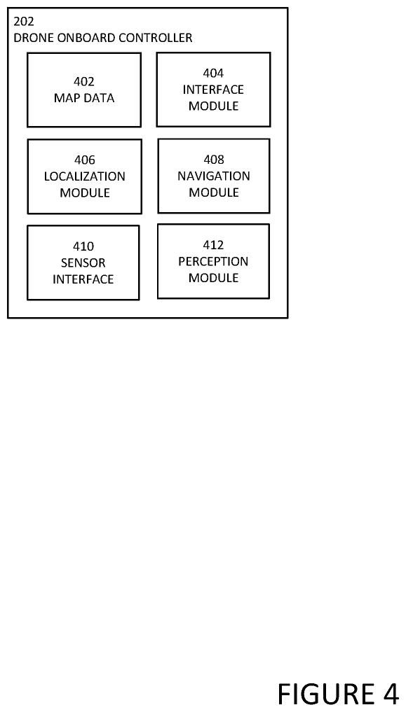

FIG. 2 is a block diagram illustrating the AV assist drone 104 according to some embodiments of the present disclosure. The AV assist drone 104 can include a drone onboard controller 202, a drone sensor suite 204, a user guidance module 206, user guidance devices 208, a flight controller 210, and an onboard battery 212. The drone onboard controller 202 can help the AV assist drone 104 identify objects in the environment around the AV assist drone 104 and navigate in the environment around the AV assist drone 104. The drone onboard controller 202 is explained in more detail with reference to FIG. 4. The drone sensor suite 204 can include one or more sensors that can help the AV assist drone identify objects and conditions in the environment around the AV assist drone 104. The drone sensor suite 204 is explained in more detail with reference to FIG. 3. The user guidance module 206 can determine a path that can be used to guide or lead a user of an AV service associated with the AV 102 to the AV 102 and is explained in more detail with reference to FIG. 3. The user guidance devices 208 can help provide some visual or audio guide for the user of the AV service associated with the AV 102 to help guide the user along a path to the AV 102 and is explained in more detail with reference to FIG. 3. The flight controller 210 can help enable the AV assist drone 104 to operate during flight when the drone is deployed. The onboard battery 212 can power the AV assist drone 104. The onboard battery 212 may be a lithium-ion battery, a lithium polymer battery, a lead-acid battery, a nickel-metal hydride battery, a sodium nickel chloride (“zebra”) battery, a lithium-titanate battery, or another type of rechargeable battery.

When the AV assist drone 104 is not deployed and airborne, the AV assist drone 104 can be coupled and/or secured to the AV assist drone housing 110. The AV assist drone housing 110 can include one or more AV assist drone securing mechanisms 214 and one or more AV assist drone charging mechanisms 216. The one or more AV assist drone securing mechanisms 214 may be magnets, electro magnets that are activated when the drone is on the AV assist drone housing 110, a mechanical securing mechanism (e.g., mechanical clamps or hooks that couple and secure the AV assist drone 104 to the AV assist drone housing 110) or some other mechanism that can help to secure the AV assist drone 104 to the AV assist drone housing 110. The AV assist drone charging mechanisms 216 can help to recharge the onboard battery 212 when the AV assist drone 104 is coupled to the AV assist drone housing 110. In some examples, the AV assist drone charging mechanisms 216 is a wireless charger or inductive charger that transfers energy from the AV assist drone charging mechanisms 216 to the onboard battery 212 through electromagnetic induction to recharge the onboard battery 212.

In some examples, the AV assist drone housing 110 is a landing pad for the AV assist drone 104. While FIG. 2 illustrates a specific size, shape, and location of the AV assist drone housing 110, the size, shape, location, and other features of the AV assist drone housing 110 depend on design choice and design constraints. More specifically, the AV assist drone housing 110 can be a semi-closed housing with one or more side walls to help protect the AV assist drone 104 from the environment around the AV 102 (e.g., rain, wind, etc.).

The AV assist drone 104 also includes a main body 218 and a plurality of propulsion assemblies 220a-220d. Each of the propulsion assemblies 220a-220d can include a motor, and a plurality of rotor blades. More specifically, as illustrated in FIG. 2, the propulsion assembly 220a includes a motor 222a and rotor blades 224a, the propulsion assembly 220b includes a motor 222b and rotor blades 224b, the propulsion assembly 220c includes a motor 222c and rotor blades 224c, and the propulsion assembly 220d includes a motor 222d and rotor blades 224d.

Each of the propulsion assemblies 220a-220d can be coupled to a motor support arm. For example, as illustrated in FIG. 2, the propulsion assembly 220a is coupled to a motor support arm 126a, the propulsion assembly 220b is coupled to a motor support arm 126b, the propulsion assembly 220c is coupled to a motor support arm 126c, and the propulsion assembly 220d is coupled to a motor support arm 126d. Each motor support arm 126a-126d is coupled to the main body 218.

The main body 218 can help provides lift to the AV assist drone 104 during forward flight while also maintaining a relatively small footprint of the AV assist drone 104. Each of the motor support arms 226a-226d provide structure and support to propulsion assemblies 220a-220d during operation of the AV assist drone 104. In some examples, the main body 218 and/or the propulsion assemblies 220a-220d can help to provide a base or surface for landing the drone 104 on the AV assist drone housing 110 and can function as the landing gear for the AV assist drone 104. In the embodiment shown, each motor 222a-222d is an electric motor. However, in other embodiments, each motor 222a-222d may be a combustion engines or auxiliary power unit through a plurality of interconnect driveshafts and/or auxiliary gearboxes.

Furthermore, the rotational speeds of each rotor blades 224 may be selectively controlled to orient the AV assist drone 104 in various flight modes. For example, surface actuators are not needed as the pitch, roll, and yaw control, both in hover and in forward flight, are provided by propulsion assemblies 220a-220d. More specifically, the AV assist drone 104 is capable of performing several maneuvers. Such maneuvers may include a roll maneuver (i.e., a rotation about a longitudinal (front to rear) axis of the AV assist drone 104, defined herein as the X axis), a pitch maneuver (i.e., a rotation about a lateral (right to left) axis of the AV assist drone 104, defined herein as the Y axis) and/or a yaw maneuver (i.e., a rotation about a vertical (top to bottom) axis of the AV assist drone 104, defined herein as the Z axis). More specifically, for hover control, pitch (attitude) can be controlled using upper and lower differential thrust from propulsion assemblies 220a-220d, roll (attitude) can be controlled using left horizontal/right horizontal (LH-RH) differential thrust from propulsion assemblies 220a-220d, and yaw (heading) can be controlled using differential torque of propulsion assemblies 220a-220d. For forward flight control, pitch can be controlled using upper and lower differential thrust from propulsion assemblies 220a-220d, roll can be controlled using differential torque of propulsion assemblies 220a-220d, and yaw can be controlled using LH-RH differential thrust from propulsion assemblies 220a-220d.

FIG. 3 is a block diagram illustrating the AV assist drone 104 according to some embodiments of the present disclosure. The AV assist drone 104 can include the drone onboard controller 202, the drone sensor suite 204, the user guidance module 206, the user guidance devices 208, the flight controller 210, the onboard battery 212, one or more processors 302, memory 304, an AV interface module 306, and a communication module 308. The drone onboard controller 202 can help the AV assist drone 104 identify objects in the environment around the AV assist drone 104 and navigate in the environment around the AV assist drone 104.

The drone sensor suite 204 can include one or more microphones 310, one or more cameras 312, one or more LIDAR 314, a location module 316, one or more IR detectors 318, one or more light detectors 320, a barometer 322, one or more odor sensors 324, one or more radiation sensors 326, one or more chemical sensors 328, one or more beacon receivers 330, and one or more biometric sensors 332. The drone sensor suite 204 may have more types of sensors than those shown in FIG. 3. In other embodiments, the drone sensor suite 204 may not include one or more of the sensors shown in FIG. 3.

The one or more microphones 310 can convert sound into electrical signals. In some examples, the one or more microphones 310 may be used to authenticate the identity of a user of an AV service associated with the AV 102 (not shown). In another example, the one or more microphones 310 may be used to generate sensor data for the AV assist drone 104 and/or the AV 102 while the AV assist drone 104 is in the user of an AV service assist mode, the clear occlusion mode, the refined routing mode, the security mode, or the search and rescue mode.

The one or more cameras 312, can capture different views from the AV assist drone 104 and may include a high-resolution imager with a fixed mounting and field of view and/or may have adjustable field of views and/or adjustable zooms. In an example, the one more or more cameras 312 may be used to authenticate the identity of a user of an AV service associated with the AV 102. In in another example, the one more or more cameras 312 may be used to supplement cameras on the AV 102. In yet other examples, the one or more cameras 312 may be used to generate sensor data for the AV assist drone 104 and/or the AV 102 while the AV assist drone 104 is in the user of an AV service assist mode, the clear occlusion mode, the refined routing mode, the security mode, or the search and rescue mode.

The one or more LIDAR 314 measures distances to objects in the vicinity of the user device AV assist drone 104 using reflected laser light. In an example, the one more or more LIDAR 314 may be used to identify an object or a user of an AV service associated with the AV 102. In some examples, the one or more LIDAR 314 may be used to generate sensor data for the AV assist drone 104 and/or the AV 102 while the AV assist drone 104 is in the user of an AV service assist mode, the clear occlusion mode, the refined routing mode, the security mode, or the search and rescue mode. The location module 316 may include a global positioning system (GPS) sensor or some other type of sensor or device that can determine a location of the AV assist drone 104. In an example, the location module 316 may be used to generate sensor data for the AV assist drone 104 and/or the AV 102 while the AV assist drone 104 is in the user of an AV service assist mode, the clear occlusion mode, the refined routing mode, the security mode, or the search and rescue mode. The one or more IR detectors 318 is a radiation-sensitive optoelectronic component with a spectral sensitivity in the infrared wavelength range of about 780 nm to about 50 μm. In an example, the one more or more IR detectors 318 may be used to identify an object or a user of an AV service associated with the AV 102. In some examples, the one or more IR detectors 318 may be used to generate sensor data for the AV assist drone 104 and/or the AV 102 while the AV assist drone 104 is in the user of an AV service assist mode, the clear occlusion mode, the refined routing mode, the security mode, or the search and rescue mode. The one or more light detectors 320 can detect the amount of light around the AV assist drone 104 by converting light energy into an electrical signal output. In an example, the one or more light detectors 320 can be used to determine if the lighting around a user of an AV service associated with the AV 102 needs additional lighting to help guide the user to the AV 102 and/or to create a safe environment around the user. In some examples, the one or more light detectors 320 may be used to generate sensor data for the AV assist drone 104 and/or the AV 102 while the AV assist drone 104 is in the user of an AV service assist mode, the clear occlusion mode, the refined routing mode, the security mode, or the search and rescue mode.

The barometer 322 is a sensor that can detect atmospheric pressure in the vicinity of the AV assist drone 104. In some examples, the barometer 322 can be used by the AV assist drone 104 and/or the AV 102 to help predict short term changes in the weather (e.g., a strong storm is near). In some examples, the barometer 322 may be used to generate sensor data for the AV assist drone 104 and/or the AV 102 while the AV assist drone 104 is in the user of an AV service assist mode, the clear occlusion mode, the refined routing mode, the security mode, or the search and rescue mode. The one or more odor sensors 324 is a sensor that can detect one or more odors in the vicinity of the AV assist drone 104. In an example, the one or more odor sensors 324 can be used by the AV assist drone 104 and/or the AV 102 to help locate a specific odor or determine a source of a specific odor. In some examples, the one or more odor sensors 324 may be used to generate sensor data for the AV assist drone 104 and/or the AV 102 while the AV assist drone 104 is in the user of an AV service assist mode, the clear occlusion mode, the refined routing mode, the security mode, or the search and rescue mode. The one or more radiation sensors 326 can detect a level of radiation in the vicinity of the AV assist drone 104. In some examples, one or more radiation sensors 542 may be used to track, detect, or identify high-energy particles or radiation from natural or artificial sources such as cosmic radiation, nuclear decay, particle accelerators, and X-rays. In an example, the one or more radiation sensors 326 can be used by the AV assist drone 104 and/or the AV 102 to help determine if radiation levels in a specific area are within a safe level. In some examples, the one or more radiation sensors 326 may be used to generate sensor data for the AV assist drone 104 and/or the AV 102 while the AV assist drone 104 is in the user of an AV service assist mode, the clear occlusion mode, the refined routing mode, the security mode, or the search and rescue mode. The one or more chemical sensors 328 can be a chemical detector that can detect a specific chemical in the area of the AV assist drone 104. In general, chemical sensors are specialized sensors or chemical detectors that can detect a specific type of chemical or class of chemicals. For example, some chemical detectors can detect gasses such as methane, some chemical detectors can detect explosives such as nitroglycerin, and other chemical detectors can detect narcotic substances such as marijuana. In some examples, the one or more chemical sensors 328 may be used to generate sensor data for the AV assist drone 104 and/or the AV 102 while the AV assist drone 104 is in the user of an AV service assist mode, the clear occlusion mode, the refined routing mode, the security mode, or the search and rescue mode.

The one or more beacon receivers 330 are a wireless sensor that receives a signal from a beacon. Some beacons are location-based beacons and the one or more beacon receivers 330 can be used by the AV assist drone 104 to help determine a general location of the AV assist drone 104. In some examples, the one or more beacon receivers 330 may be used to generate sensor data for the AV assist drone 104 and/or the AV 102 while the AV assist drone 104 is in the user of an AV service assist mode, the clear occlusion mode, the refined routing mode, the security mode, or the search and rescue mode. The one or more biometric sensors 332 can determine one or more biometrics of a user (e.g., heartrate, skin temperature, pulse, etc.). In an example, the one more or more biometric sensors 332 may be used to identify and help authenticate a user of an AV service associated with the AV 102.

The user guidance module 206 can determine a path or direction for the user to guide or lead a user of an AV service associated with the AV 102 to the AV 102. For example, the user guidance module 206 can identify a location of the user, identify obstacles around the user (e.g., other people, a physical barrier such as a tree, a vehicle, curb, etc.) and determine a path or direction for the user to follow that will guide the user to the AV 102. The user guidance devices 208 can help provide some visual or audio guide for the user of the AV service associated with the AV 102 to help guide the user to the AV 102. For example, as illustrated in FIG. 3, the user guidance devices 208 can include a laser pointer 334, a light source 336, a speaker 338, and a display 340. In an example, using the laser pointer 334, the user guidance module 206 can cause an arrow to be displayed on the ground near the user 602 and the arrow can point in the direction of the AV 102. In another example, using the laser pointer 334, the user guidance module 206 can cause a line to be displayed on the ground near the user 602 and the line can follow a path that leads the AV 102.

In an example, using the light source 336, the user guidance module 206 can cause a beam of light to be displayed on the ground near the user and the user can follow the beam of light to the AV 102. In another example, the one or more light detectors 320 can be used to determine if the lighting around a user of an AV service associated with the AV 102 needs additional lighting to help guide the user to the AV 102 and/or to create a safe environment around the user and if additional lighting is needed, the light source 336 can help provide the additional lighting. In yet another example, the light source 336 can be used to help illuminate an obstruction to assist the AV assist drone 104 and/or AV 102 in identifying the obstruction. In another example, the light source 336 can be used to help illuminate an environment during a nighttime search and rescue operation.

In an example, using the speaker 338, the user guidance module 206 can cause a sound to be emitted from the speaker 338 for the user to help guide the user in the direction of the AV 102. In some examples, the sound may be audio directions to the user (e.g., turn left and walk in a straight line for five feet to reach the AV 102). In other examples, the sound may be a short burst sound such as a beep that the user follows to the AV 102. The frequency of the sound can become shorter with quicker busts of sound as the user becomes closer and closer to the AV 102. In some examples, any text or sound from the speaker 338 can also be displayed on the display 340. For example, audio directions can be displayed on the display 340. If a short burst sound is used to guide the user to the AV 102, the display 340 could display a visual representation of the short burst sound (e.g., a starburst or visual explosion that pulses and the pulses become faster and larger as the user becomes closer and closer to the AV 102).

In an example, using the display 340, the user the user guidance module 206 can cause a guidance information to be displayed on the display 340 and the user can follow the guidance information on the display 340 to the AV 102. More specifically, the display 340 can display an arrow and the arrow can point in the direction of the AV 102. Also, the display 340 can display text such as “FOLLOW ME TO YOUR VEHICLE,” “YOUR VEHICLE IS AROUND THE NEXT CORNER TO YOUR RIGHT,” or some other guidance information displayed on the display 340 that can help guide the user to the AV 102. In some examples, any guidance information, especially text, displayed on the display 340 can also be presented to the user in audio form using the speaker 338.

The user guidance module 206 can use one or more of the laser pointer 334, the light source 336, the speaker 338, and the display 340 to help guide the user to the AV 102. For example, the laser pointer 334 or light source 336 can cause an arrow to be displayed on the ground near the user and the speaker 338 and/or display 340 can provide instructions to the user requesting that the user follow the arrow to the AV 102. In other examples, the laser pointer 334 or light source 336 can cause an arrow to be displayed on the ground near the user and the speaker 338 and/or the display 340 can provide information or a message to the user. More specifically, while the arrow or some other guidance is being displayed on the ground by the laser pointer 334 or the light source 336, the speaker 338 and/or display 340 can provide the message “YOUR VEHICLE IS 5 FEET IN FRONT OF YOU,” “THANK YOU FOR USING OUR COMPANY FOR YOUR RIDESHARE NEEDS,” or some other information or message.

The flight controller 210, can help enable the AV assist drone 104 to operate during flight. The flight controller 210 can include a control module 342, an orientation module 344, and a payload sensor 346. The control module 342 can include a propulsion control system and other electronics to control the AV assist drone 104 during flight when the AV assist drone 104 is deployed. The orientation module 344 can help stabilize the AV assist drone 104 during flight when the AV assist drone 104 is deployed. If the AV assist drone 104 is deployed in a package delivery mode, the payload sensor 346 can assist with the collection and delivery of the package.

The communication module 308 helps the communication AV interface module 306 communicate with the AV assist drone interface module 504 in the AV onboard controller 106 (illustrated in FIG. 5) of the AV 102. In some examples, the AV interface module 306 is the same as or is included as part of the interface module 404 (illustrated in FIG. 4) in the AV assist drone onboard controller 202. The communication module 308 can help facilitate bi-directional wired and wireless communication. In some examples, the communication module 308 includes one or more of a WiFi module 348 to help facilitate WiFi communications, a Bluetooth module 350 to help facilitate Bluetooth™ communications, an NFC module 352 to help facilitate NFC communications, and a beacon 354. The beacon 354 can broadcast a signal that can be detected by a least one beacon sensor (e.g., a beacon sensor in the AV sensor suite 108 of the AV 102).

Example AV Assist Drone Onboard Controller

FIG. 4 is a block diagram illustrating the AV assist drone onboard controller 202 of the AV assist drone 104 according to some embodiments of the present disclosure. The AV assist drone onboard controller 202 includes drone map data 402, an interface module 404, a drone localization module 406, a drone navigation module 408, a drone sensor interface 410, a drone perception module 412, and an AV interface module 414. Alternative configurations and different or additional components may be included in the AV assist drone onboard controller 202. Further, functionality attributed to one component of the AV assist drone onboard controller 202 may be accomplished by a different component included in the AV assist drone 104 or a different system (e.g., the AV onboard controller 106 or the fleet management system 2102). For example, components and modules for conducting route planning, controlling movements of the AV assist drone 104, and other functions are not shown in FIG. 4.

The drone map data 402 stores a detailed map that includes a current environment around the AV assist drone 104 and/or the AV 102. The drone map data 402 can be used by the AV assist drone 104 to help the AV assist drone 104 navigate during deployment of the AV assist drone 104. In some examples, the drone map data 402 can include the location of occlusions and/or areas in the environment where the AV assist drone 104 can help supplement the sensors on the AV 102 to allow the AV 102 to identify objects, or a lack of objects, in areas that are occluded or areas that are blind to the sensors on the AV 102. The drone map data 402 may include any of the map data 502 (described in relation to FIG. 5). In some embodiments, the drone map data 402 stores a subset of the map data 502, (e.g., map data for a city or region in which the AV 102 is located).

In some examples, the AV interface module 306 (illustrated in FIG. 3) is the same as or is included as part of the interface module 404. The interface module 404 facilitates bi-directional wired and wireless communication communications of the AV assist drone onboard controller 202 with other systems. For example, the interface module 404 supports communications of the AV assist drone onboard controller 202 with other systems (e.g., the AV onboard controller 106 or the fleet management system 2102). In addition, the interface module 404 supports communications of the AV assist drone onboard controller 202 with other components of the AV assist drone and AV 102. For example, the interface module 404 may retrieve sensor data generated by the drone sensor suite 204 of the AV assist drone 104 and communicate the sensor data to the AV 102.

The drone localization module 406 localizes the AV assist drone 104. The drone localization module 406 may use sensor data generated by the drone sensor suite 204 and/or the AV sensor suite 108 in the AV 102 to determine the current location of the AV assist drone 104. The sensor data includes information describing an absolute or relative position of the AV assist drone 104 (e.g., data generated by GPS, global navigation satellite system (GNSS), IMU, etc.), information describing features surrounding the AV assist drone 104 (e.g., data generated by a camera, RADAR, SONAR, LIDAR, etc.), information describing motion of the AV assist drone 104 (e.g., data generated by the motion sensor), or some combination thereof.

In some embodiments, the drone localization module 406 determines whether the AV assist drone 104 is at a predetermined location (e.g., a location of a user of an AV service). For example, the drone localization module 406 uses sensor data generated by the drone sensor suite 204 and/or the AV sensor suite 108 in the AV 102 to determine the location of the AV assist drone 104. The drone localization module 406 may further compare the location of the AV assist drone 104 with the predetermined location to determine whether the AV assist drone 104 has arrived at a destination. The drone localization module 406 may provide locations of the AV assist drone 104 and/or the AV 102 to the fleet management system 2102.

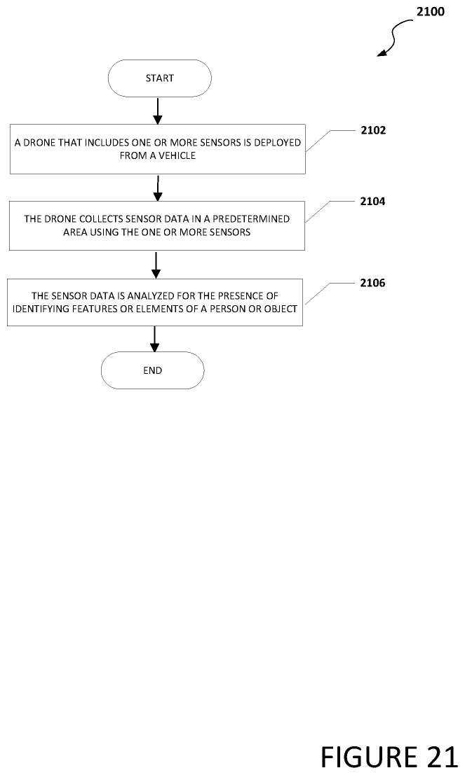

The drone localization module 406 can further localize the AV assist drone 104 and/or the AV 102 within a local area. For example, the drone localization module 406 determines a pose (position or orientation) of the AV assist drone 104 and/or the AV 102 in the local area. In some embodiments, the drone localization module 406 localizes the AV assist drone 104 and/or the AV 102 within the local area by using a model of the local area. The model may be a 2D or 3D representation of the surrounding area, such as a map or a 3D virtual scene simulating the surrounding area. In various embodiments, the drone localization module 406 receives the model of the local area from the fleet management system 2102 (illustrated in FIG. 21). The drone localization module 406 may send a request for the model to the fleet management system 2102 and in response, receive the model of the local area. In some embodiments, the drone localization module 406 generates the request based on sensor data indicating a position or motion of the AV assist drone 104 and/or the AV 102.

The drone localization module 406 may further localize the AV assist drone 104 and/or the AV 102 with respect to an object in the local area. An example of the object is a building in the local area. The drone localization module 406 may determine a pose of the AV assist drone 104 and/or the AV 102 relative to the building based on features in the local area. For example, the drone localization module 406 retrieves sensor data from one or more sensors (e.g., camera, LIDAR, etc.) in the drone sensor suite 204 and/or the AV sensor suite 108 of the AV 102. The drone localization module 406 uses the sensor data to determine the pose of the AV assist drone 104 and/or the AV 102. The features may be lane markers, street curbs, driveways, and so on. A feature may be two-dimensional or three-dimensional.

The drone navigation module 408 controls motion of the AV assist drone 104 when the AV assist drone 104 is deployed. The drone navigation module 408 may control the flight controller 210 (illustrate in FIG. 3) to start, hover, pause, resume, or stop motion of the AV assist drone 104. In various embodiments, the drone navigation module 408 generates a navigation route for the AV assist drone 104 based on a location of the AV assist drone 104 and/or the AV 102, a destination, and a map. The drone navigation module 408 may receive the location of the AV assist drone 104 and/or the AV 102 from the drone localization module 406. The drone navigation module 408 receives a request to go to a location and, using drone map data 402, generates a route to navigate the AV assist drone 104 from its current location, which is determined by the drone localization module 406, to the location. The drone navigation module 408 may receive the destination from the AV 102 or the fleet management system 2102, through the interface module 404.

The drone sensor interface 410 interfaces with the sensors in the drone sensor suite 204 and/or the AV sensor suite 108 of the AV 102. The drone sensor interface 410 may request data from the drone sensor suite 204 and/or the AV sensor suite 108 of the AV 102 (e.g., by requesting that a sensor capture data in a particular direction or at a particular time). The drone sensor interface 410 may have subcomponents for interfacing with individual sensors or groups of sensors of the drone sensor suite 204 and/or the AV sensor suite 108 of the AV 102, such as a camera interface, a LIDAR interface, a radar interface, a microphone interface, etc.

The drone perception module 412 identifies objects and/or other features captured by the drone sensor suite 204 and/or the AV sensor suite 108 of the AV 102. For example, the drone perception module 412 identifies objects in the environment of the AV assist drone 104 and/or the AV 102 captured by one or more sensors of the drone sensor suite 204 and/or the AV sensor suite 108 of the AV 102. The drone perception module 412 may include one or more classifiers trained using machine learning to identify particular objects. For example, a multi-class classifier may be used to classify each object in the environment of the AV assist drone 104 and/or the AV 102 as one of a set of potential objects, (e.g., a vehicle, a pedestrian, or a cyclist). As another example, a pedestrian classifier recognizes pedestrians in the environment of the AV assist drone 104 and/or the AV 102, a vehicle classifier recognizes vehicles in the environment of the AV assist drone 104 and/or the AV 102, etc. The drone perception module 412 may identify travel speeds of identified objects based on data from a radar sensor, (e.g., speeds at which other vehicles, pedestrians, or birds are traveling). As another example, the drone perception module 412 may identify distances to identified objects based on data (e.g., a captured point cloud) from a LIDAR sensor, (e.g., a distance to a particular vehicle, building, or other feature identified by the drone perception module 412). The drone perception module 412 may also identify other features or characteristics of objects in the environment of the AV assist drone 104 and/or the AV 102 based on image data or other sensor data, for example, colors, sizes (e.g., heights of people or buildings in the environment, makes and models of vehicles, pictures and/or words on billboards, etc.).

Example AV Onboard Controller

FIG. 5 is a block diagram illustrating the AV onboard controller 106 of the AV 102 according to some embodiments of the present disclosure. The AV onboard controller 106 includes AV map data 502, an interface module 504, an AV localization module 506, an AV navigation module 508, an AV sensor interface 510, an AV perception module 512, and a drone navigation module 514. Alternative configurations, different or additional components may be included in the AV onboard controller 106. Further, functionality attributed to one component of the AV onboard controller 106 may be accomplished by a different component included in the AV 102 or a different system (e.g., the fleet management system 2102). For example, components and modules for conducting route planning, controlling movements of the AV 102, and other vehicle functions are not shown in FIG. 5.

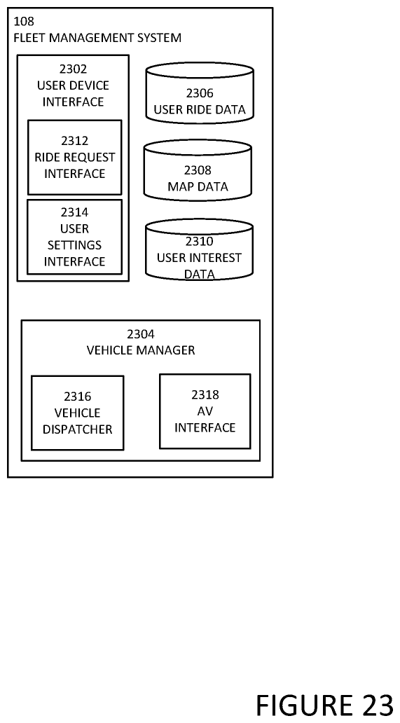

The AV map data 502 stores a detailed map that includes a current environment around the AV 102 and/or the AV assist drone 104. The AV map data 502 can be used by the AV 102 to navigate the AV 102 and/or to navigate the AV assist drone 104 during deployment of the AV assist drone 104. In some examples, the AV map data 502 can include the location of occlusions and/or areas in the environment where the AV assist drone 104 can help supplement the sensors on the AV 102 to allow the AV 102 to identify objects, or a lack of objects, in areas that are occluded or areas that are blind to the sensors on the AV 102. The AV map data 502 may include any of the map data 2308 described in relation to FIG. 23. In some embodiments, the AV map data 502 stores a subset of the map data 2308, (e.g., map data for a city or region in which the AV 102 is located).

The interface module 504 facilitates bi-directional wired and wireless communications of the AV onboard controller 106 with other systems. For example, the interface module 504 supports communications of the AV onboard controller 106 with other systems (e.g., the drone onboard controller 202 or the fleet management system 2102). The interface module 504 supports communications of the AV onboard controller 106 with other components of the AV 102. For example, the interface module 142 may retrieve sensor data generated by the drone sensor suite 204 of the AV assist drone 104 and/or the AV sensor suite 108 and communicate with an UI module of the AV onboard controller 106.

The AV localization module 506 localizes the AV 102 and/or the AV assist drone 104. The AV localization module 506 may use sensor data generated by the AV sensor suite 108 and/or the drone sensor suite 204 to determine the current location of the AV 102 and/or AV assist drone 104. The sensor data includes information describing an absolute or relative position of the AV 102 (e.g., data generated by GPS, global navigation satellite system (GNSS), IMU, etc.), information describing features surrounding the AV 102 (e.g., data generated by a camera, RADAR, SONAR, LIDAR, etc.), information describing motion of the AV 102 (e.g., data generated by the motion sensor), or some combination thereof. In some embodiments, the AV localization module 506 uses the sensor data to determine whether the AV 102 has entered a local area, such as a parking garage or parking lot where the AV 102 can be charged. In some other embodiments, the AV localization module 506 may send the sensor data to the fleet management system 2102 and receive from the fleet management system 2102 a determination whether the AV 102 has entered the local area.

In some embodiments, the AV localization module 506 determines whether the AV 102 is at a predetermined location (e.g., a destination of an AV service). For example, the AV localization module 506 uses sensor data generated by the AV sensor suite 108 and/or the drone sensor suite 204 (or a sensor in the AV sensor suite 108 or a sensor in the drone sensor suite 204) to determine the location of the AV 102. The AV localization module 506 may further compare the location of the AV 102 with the predetermined location to determine whether the AV 102 has arrived at a destination. The AV localization module 506 may provide locations of the AV 102 to the fleet management system 2102.

The AV localization module 506 can further localize the AV 102 within the local area. For example, the AV localization module 506 determines a pose (position or orientation) of the AV 102 in the local area. In some embodiments, the AV localization module 506 localizes the AV 102 within the local area by using a model of the local area. The model may be a 2D or 3D representation of the surrounding area, such as a map or a 3D virtual scene simulating the surrounding area. In various embodiments, the AV localization module 506 receives the model of the local area from the fleet management system 2102. The AV localization module 506 may send a request for the model to the fleet management system 2102 and in response, receive the model of the local area. In some embodiments, the AV localization module 506 generates the request based on sensor data indicating a position or motion of the AV 102. For example, the AV localization module 506 detects that the AV 102 is in the local area or is navigated to enter the local area based on the sensor data and sends out the request in response to such detection. This process can be dynamic. For example, the AV localization module 506 may send new request to the fleet management system 2102 as the AV 102 changes its position.

The AV localization module 506 may further localize the AV 102 with respect to an object in the local area. An example of the object is a building in the local area. The AV localization module 506 may determine a pose of the AV 102 relative to the building based on features in the local area. For example, the AV localization module 506 retrieves sensor data from one or more sensors (e.g., camera, LIDAR, etc.) in the AV sensor suite 108 and/or the drone sensor suite 204 that detect the features in the environment of the AV 102. The AV localization module 506 uses the sensor data to determine the pose of the AV 102. The features may be lane markers, street curbs, driveways, and so on. A feature may be two-dimensional or three-dimensional.

The AV navigation module 508 controls motion of the AV 102 and/or the AV assist drone 104. The AV navigation module 508 may control the motor of the AV 102 to start, pause, resume, or stop motion of the AV 102. The AV navigation module 508 may further control the wheels of the AV 102 to control the direction the AV 102 will move. The AV navigation module 508 may also control the flight of the AV assist drone 104 when the AV assist drone 104 is deployed.

In various embodiments, the AV navigation module 508 generates a navigation route for the AV 102 based on a location of the AV 102, a destination, and a map. The AV navigation module 508 may receive the location of the AV 102 from the AV localization module 506. The AV navigation module 508 receives a request to go to a location and, using AV map data 502, generates a route to navigate the AV 102 from its current location, which is determined by the AV localization module 506, to the location. The AV navigation module 508 may receive the destination from the fleet management system 2102, through the interface module 142. In some examples, the AV navigation module 508 generates a navigation route for the AV assist drone 104 based on a location of the AV 102 and/or the AV assist drone 104, a destination, and a map (e.g., from the drone map data 402 and/or the map data 502).

The AV sensor interface 510 interfaces with the sensors in the AV sensor suite 108 and, in some examples, the sensors from the drone sensor suite 204. The AV sensor interface 510 may request data from the AV sensor suite 108 and/or the drone sensor suite 204 (e.g., by requesting that a sensor capture data in a particular direction or at a particular time). The AV sensor interface 510 is configured to receive data captured by sensors of the AV sensor suite 108 and/or the drone sensor suite 204. The AV sensor interface 510 may have subcomponents for interfacing with individual sensors or groups of sensors of the AV sensor suite 108 and/or the drone sensor suite 204, such as a camera interface, a LIDAR interface, a radar interface, a microphone interface, etc.

The perception module 512 identifies objects and/or other features captured by the AV sensor suite 108 of the AV 102 and/or the drone sensor suite 204 of the AV assist drone 104. For example, the perception module 512 identifies objects in the environment of the AV 102 and captured by one or more sensors of the AV sensor suite 108 and/or one or more sensors of the drone sensor suite 204. The perception module 512 may include one or more classifiers trained using machine learning to identify particular objects. For example, a multi-class classifier may be used to classify each object in the environment of the AV 102 as one of a set of potential objects, (e.g., a vehicle, a pedestrian, or a cyclist). As another example, a pedestrian classifier recognizes pedestrians in the environment of the AV 102, a vehicle classifier recognizes vehicles in the environment of the AV 102, etc. The perception module 512 may identify travel speeds of identified objects based on data from a radar sensor, (e.g., speeds at which other vehicles, pedestrians, or birds are traveling). As another example, the perception module 512 may identify distances to identified objects based on data (e.g., a captured point cloud) from a LIDAR sensor, (e.g., a distance to a particular vehicle, building, or other feature identified by the perception module 512). The perception module 512 may also identify other features or characteristics of objects in the environment of the AV 102 based on image data or other sensor data, for example, colors (e.g., the color of a specific building or house), sizes (e.g., heights of people or buildings in the environment), makes and models of vehicles, pictures and/or words on billboards, etc.

In some embodiments, the perception module 512 fuses data from one or more sensors in the AV sensor suite 108 of the AV 102, one or more sensors in the drone sensor suite 204 of the AV assist drone 104, and/or AV map data 502 to identify environmental features around the AV 102. While a single perception module 512 is shown in FIG. 5, in some embodiments, the AV onboard controller 106 may have multiple perception modules (e.g., different perception modules for performing different ones of the perception tasks described above (e.g., object perception, speed perception, distance perception, feature perception, facial recognition, mood determination, sound analysis, gaze determination, etc.)).

The drone navigation module 514 allows for bi-directional communication between the AV onboard controller 106 and the AV assist drone 104. In some examples, the bi-directional communication is wireless communication. In some examples, the drone navigation module 514 can fully control the AV assist drone 104 after the AV assist drone 104 is deployed. In other examples, the drone navigation module 514 provides general guidance or a specific command or task for the AV assist drone 104 to execute and the drone onboard controller 202 uses the drone navigation module 408 and flight controller 210 to control the AV assist drone 104 after the AV assist drone 104 is deployed.

Example System Summary

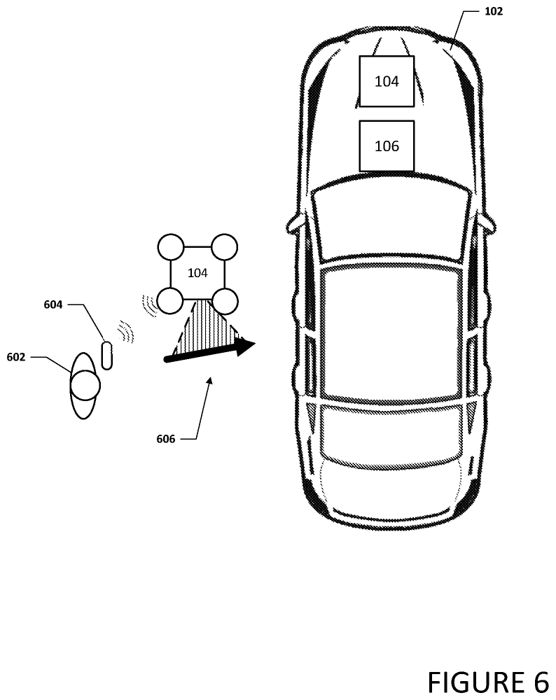

FIG. 6 illustrates the AV assist drone 104 deployed from the AV 102 in a user of an AV service assist mode according to some embodiments of the present disclosure. In an example, the AV assist drone 104 can deploy from the AV 102 and travel towards a user 602 of an AV service. In some examples, the user 602 has a user device 604.

The AV assist drone 104 can authenticate the user 602 and guide the user 602 towards the AV 102. In an example, the AV assist drone 104 authenticates the user 602 using one or more sensors in the drone sensor suite 204. More specifically, the one or more cameras 312, the one or more LIDAR 314, the one or more biometric sensors 332 or some other sensor may be used to authenticate the user 602. In another example, the AV assist drone 104 authenticates the user 602 through the user device 604. For example, the AV assist drone 104 can receive a validation code from the user device 604 or some other type of communication that can be used to authenticate the user 602 through the user device 604. In other examples, the user 602 is not authenticated by the AV assist drone 104 and the user is given a message or some type of prompt on the user device 604 to follow the AV assist drone 104 to the AV 102.

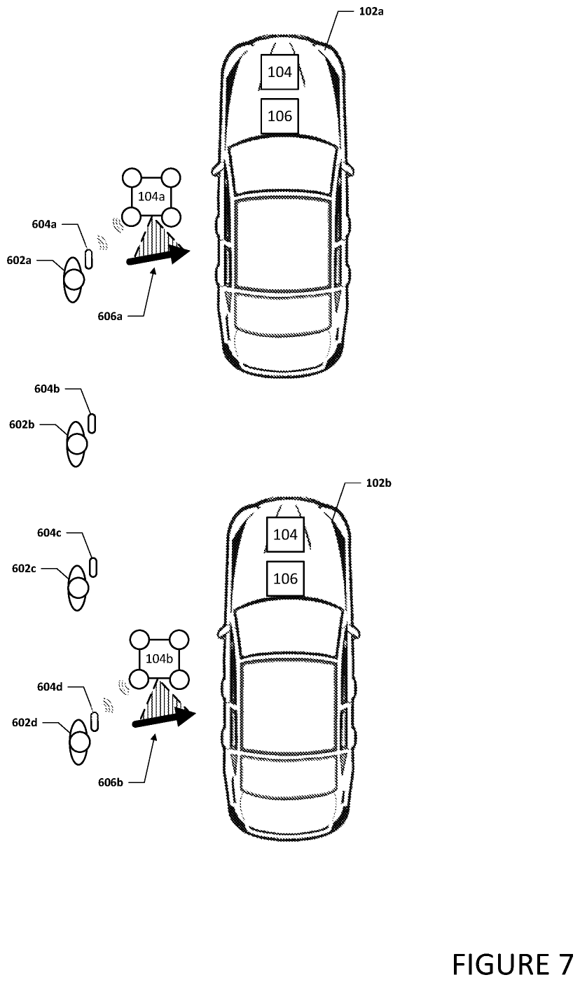

The AV assist drone 104 can project an indicator 606 to guide the user 602 to the AV 102. More specifically, as illustrated in FIG. 7, the indicator can be an arrow and, using the laser pointer 334, the user guidance module 206 in the AV assist drone 104 can cause the arrow to be displayed on the ground near the user 602 and the arrow can point in the direction of the AV 102. In another example, using the laser pointer 334, the user guidance module 206 can cause a line to be displayed on the ground near the user 602 and the line can follow a path that leads the AV 102.

The user device 604 can include a display, a processor, memory, an AV assist drone/AV interface module, and a communication module. The display can provide graphical information to the user. In some examples, the display is a touchscreen display and provides a user interface. The AV assist drone/AV interface module is configured to communicate with the AV assist drone 104 and the AV 102 and allows for bi-directional communication between the user device 604 and the AV assist drone 104 and the AV 102.

The user device 604 is one or more computing devices capable of receiving user input as well as transmitting and/or receiving data via a network (e.g., the network 2208 illustrated in FIG. 22). The user device 604 can be used to request use of the AV 102. For example, the user device 604 may send an AV service request through an application executed on the user device 604. In one embodiment, the user device 604 is a device having computer functionality, such as a personal digital assistant (PDA), a mobile telephone, a smartphone, or another suitable device.

FIG. 7 illustrates a plurality of the AV assist drones 104 deployed from the AV 102 in a user of an AV service assist mode according to some embodiments of the present disclosure. In an example, a plurality of users 702a-702d can be waiting for an AV associated with the AV service. In some examples, the users 702a-702d can each have an associated user device 604a-604d respectively. In an example, the AV 102a can be associated with providing the AV service for user 602a and the AV 102b can be associated with providing the AV service for user 602d. The AV assist drone 104a can deploy from the AV 102a and travel towards the user 602a of an AV service and the AV assist drone 104b can deploy from the AV 102b and travel towards the user 602d of an AV service.

The AV assist drone 104a can authenticate the user 602a and guide the user 602a towards the AV 102a. The AV assist drone 104a can project an indicator 606a to guide the user 602a to the AV 102a. More specifically, as illustrated in FIG. 7, the indicator can be an arrow and, using the laser pointer 334, the user guidance module 206 in the AV assist drone 104a can cause the arrow to be displayed on the ground near the user 602a and the arrow can point in the direction of the AV 102a. Also, the AV assist drone 104b can authenticate the user 602d and guide the user 602d towards the AV 102b. The AV assist drone 104b can project an indicator 606b to guide the user 602d to the AV 102b. More specifically, as illustrated in FIG. 7, the indicator can be an arrow and, using the laser pointer 334, the user guidance module 206 in the AV assist drone 104b can cause the arrow to be displayed on the ground near the user 602d and the arrow can point in the direction of the AV 102b. In some examples, the indicator 606a can be a different then the indicator 606b. For example, the indicator 606a may be a different color then the color of the indicator 606b.

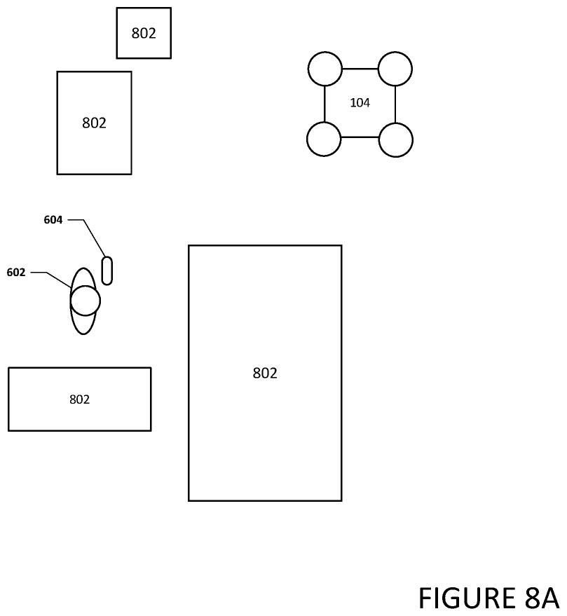

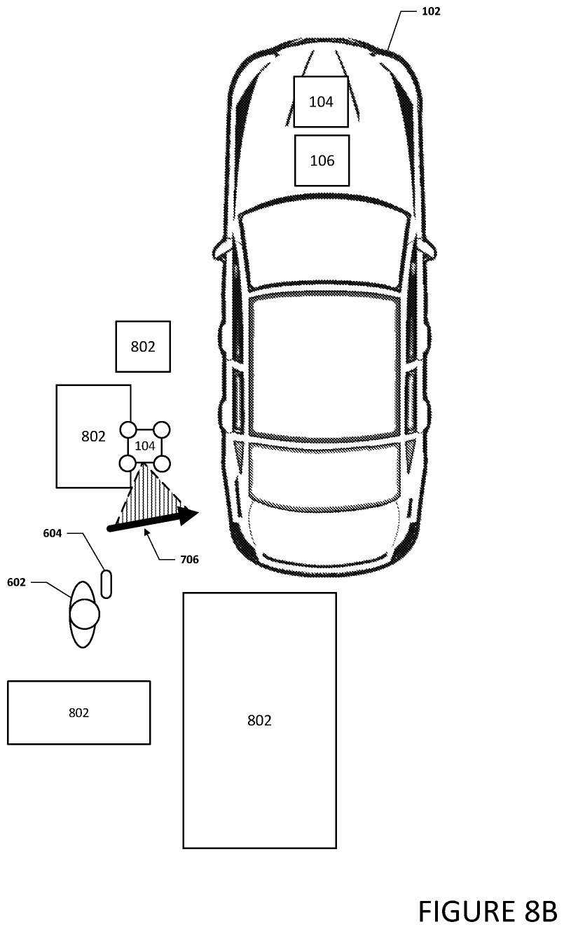

FIGS. 8A and 8B illustrate the AV assist drone 104 deployed from the AV 102 in an occlusion mode according to some embodiments of the present disclosure. In an example, the AV assist drone 104 can deploy from the AV 102 and travel towards a user 602 of an AV service. In some examples, the user 602 has a user device 604. As illustrated in FIG. 8A one or more obstructions 802 may be blocking the AV 102 from stopping in front of the user 602. In an occlusion mode example, the AV assist drone 104 can be deployed ahead of the AV 102 to determine a location of the one or more obstructions 802 relative to the user 602. For example, the AV assist drone 104 can use the one more or more cameras 312, the one more or more LIDAR 314, and/or other sensors on the AV assist drone 104 to identify the one or more obstructions 802. The sensor data identifying the one or more obstructions 802 and/or the location of the one or more obstructions 802 can be communicated from the AV assist drone 104 to the AV 102 before the AV enters the environment that includes the one or more obstructions 802. As illustrated in FIG. 8B, the AV 102 can use the sensor data from the AV assist drone 104 to identify the one or more obstructions 802 and/or the location of the one or more obstructions 802 as determined by the AV assist drone 104 and to determine a destination or stopping spot that will allow the user 602 to access the AV 102. In some examples, the AV assist drone 104 determines the destination or stopping spot for the AV 102 and communicates the location of the destination or stopping spot to the AV 102. After the AV 102 has arrived at the destination or stopping spot, the AV assist drone 104 can project an indicator 606 to guide the user 602 to the AV 102.

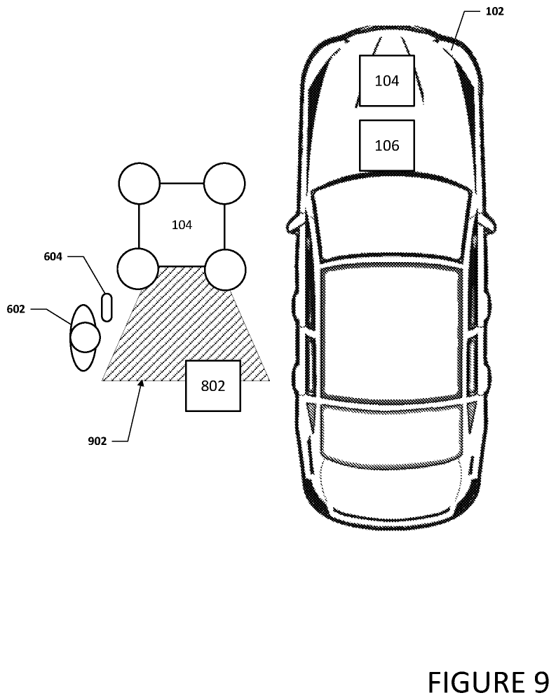

FIG. 9 illustrates the AV assist drone 104 deployed from the AV 102 in a user of an AV service assist mode according to some embodiments of the present disclosure. In an example, the AV assist drone 104 can deploy from the AV 102 and travel towards a user 602 of an AV service. In some examples, the user 602 has a user device 604.

The AV assist drone 104 can authenticate the user 602 and guide the user 602 towards the AV 102. In an example, using the light source 336, the user guidance module 206 can cause a beam of light 902 to be displayed on the ground near the user 602 and the user can follow the beam of light 902 to the AV 102. The light source 336 can be LED lights or some other type of light source. In another example, the one or more light detectors 320 can be used to determine if the lighting around a user of an AV service associated with the AV 102 needs additional lighting to help guide the user to the AV 102 and/or to create a safe environment around the user 602 and if additional lighting is needed, the light source 336 can help provide the additional lighting. In yet another example, the light source 336 can be used to help illuminate an obstruction 802 to assist the AV assist drone 104 and/or AV 102 in identifying the obstruction 802.

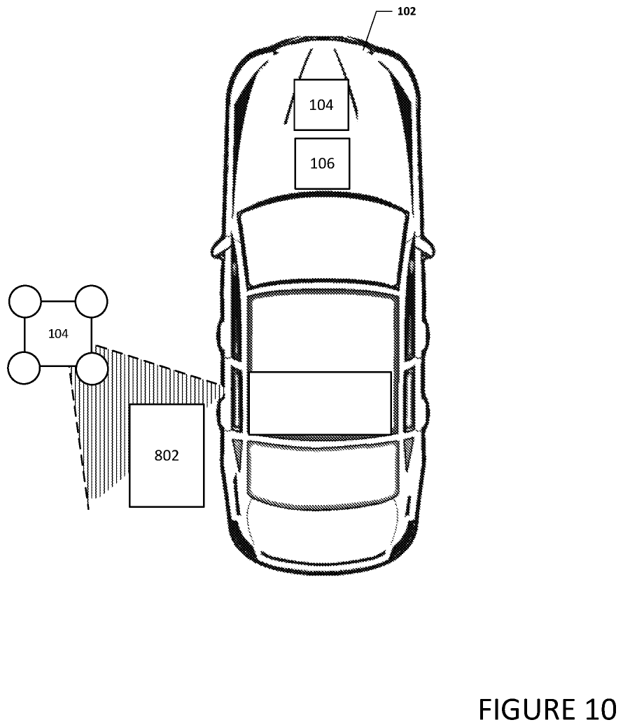

FIG. 10 illustrates the AV assist drone 104 deployed from the AV 102 in an occlusion mode according to some embodiments of the present disclosure. In an example, the AV assist drone 104 can deploy from the AV 102 and travel towards a blind spot of the vehicle. The blind spot may be because a sensor on the AV 102 has malfunctioned, an obstruction 802 is in the bind spot of the one or more LIDAR 314, or some other reason why the AV sensor suite 108 is unable to detect or identify the obstruction 802.

In an occlusion mode example, the AV assist drone 104 can be deployed to determine a location of and/or identify the obstruction 802. For example, the AV assist drone 104 can use the one more or more cameras 312, the one more or more LIDAR 314, and/or other sensors on the AV assist drone 104 to identify the obstructions 802 and/or the location of the obstruction. The sensor data identifying the obstruction 802 and/or the location of the obstruction 802 can be communicated from the AV assist drone 104 to the AV 102. The AV 102 can use the sensor data from the AV assist drone 104 to identify the obstruction 802 and/or the location of the obstruction 802 as determined by the AV assist drone 104 to avoid the obstruction 802 and in an example, determine a stopping spot that will allow the user 602 to access the AV 102. In some examples, the AV assist drone 104 autonomously identifies the obstruction 802 and/or the location of the obstruction 802 and communicates the identity of the obstruction 802 and/or the location of the obstruction 802 to the AV 102.

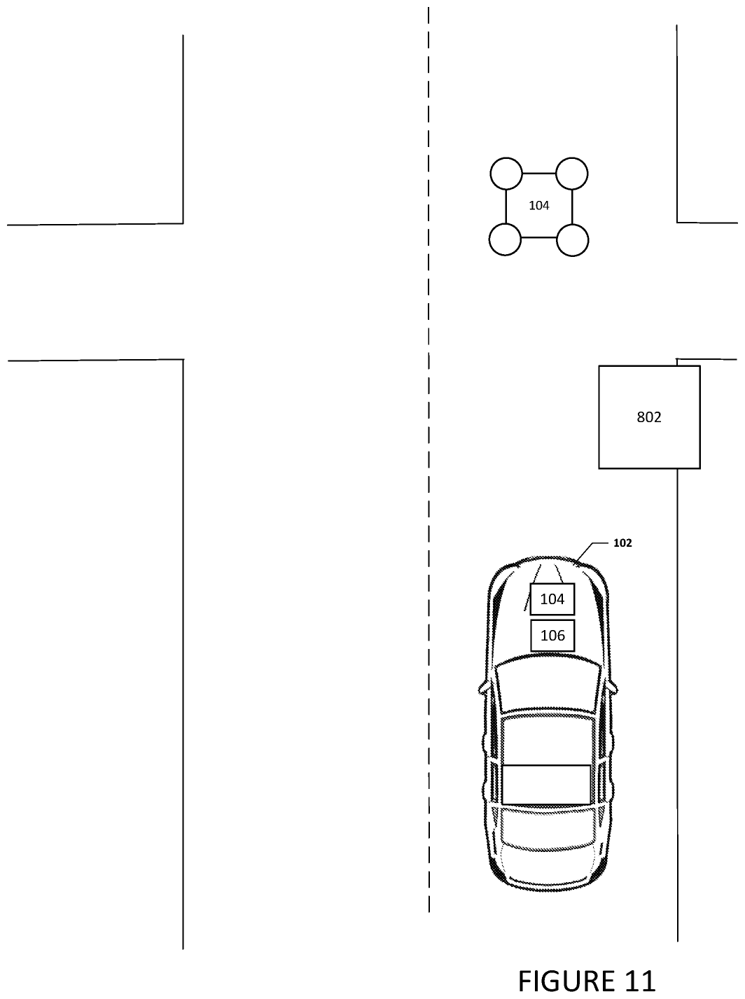

FIG. 11 illustrates the AV assist drone 104 deployed from the AV 102 in a in an occlusion mode according to some embodiments of the present disclosure. In an example, the AV assist drone 104 can deploy from the AV 102 and travel to the area around an obstruction 802 to fill in the occlusion (e.g., peak around a corner, determine what is past double-parked cars, etc.). For example, as illustrated in FIG. 11, the obstruction 802 may be blocking part of a roadway and/or the view around a corner.

The AV assist drone 104 can use the one more or more cameras 312, the one more or more LIDAR 314, and/or other sensors on the AV assist drone 104 to fill in the occlusion and the area around the obstruction 802. The sensor data collected to fill in the occlusion and the area around the obstruction 802 can be communicated from the AV assist drone 104 to the AV 102. The AV 102 can use the sensor data from the AV assist drone 104 to fill in the occlusion and the area around the obstruction 802 and determine the proper route and driving behavior.

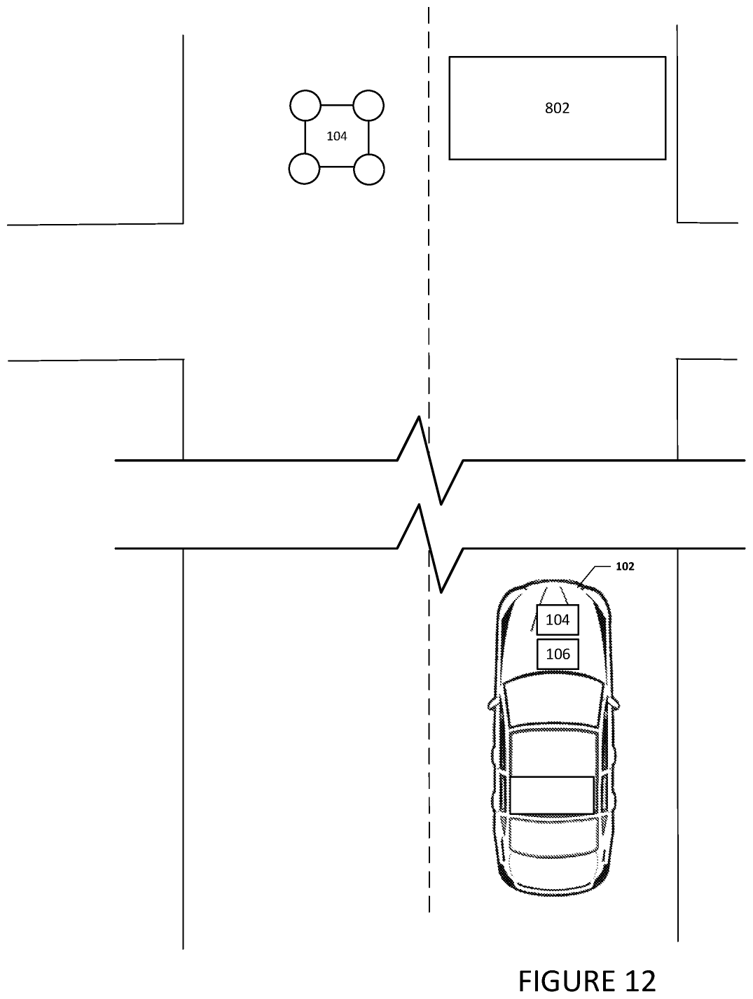

FIG. 12 illustrates the AV assist drone 104 deployed from the AV 102 in a refined routing mode according to some embodiments of the present disclosure. In an example, the AV assist drone 104 can deploy from the AV 102 and travel ahead of the AV 102. For example, as illustrated in FIG. 12, the AV assist drone 104 is deployed from the AV 102 and has traveled ahead of or in front of the AV 102. The distance the AV assist drone 104 travels ahead of or in front of the AV 102 depends on the range of the AV assist drone 104, the distance the AV assist drone 104 can travel and still be in communication with the AV 102, the distance the AV assist drone 104 needs to travel to allow the AV 102 to react to obstructions 802 and/or necessary rerouting, etc.

When the AV assist drone 104 is deployed in the refined routing mode, the AV assist drone 104 can act as a real time eye that provides a view of the upcoming route. Current route planning applications and routing applications always have a time delay and take a period of time to detect congestion, a wreck, or some obstacle blocking the route of the AV 102. The AV assist drone 104 can act as an eye in the sky to detect a just occurring obstruction 802 (e.g., a double-parked car, a traffic jam, etc.). When an obstruction 802 is detected that will affect the current route of the AV 102, a new route for the AV 102 that will avoid the obstruction 802 can be determined.

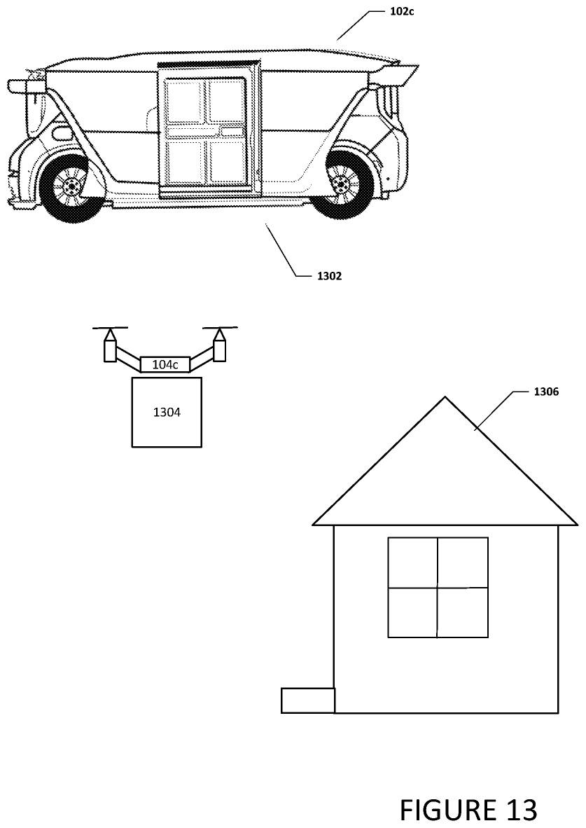

FIG. 13 illustrates an AV assist drone 104c deployed from an AV 102c in a delivery mode according to some embodiments of the present disclosure. In some examples, the AV 102c can include a delivery assembly 1302. The AV 102c can be part of a delivery service by using the delivery assembly 1302. Further, the delivery assembly 1302 can be taken out of the AV 102c so that the AV 102c can still be used for AV services or other purposes.

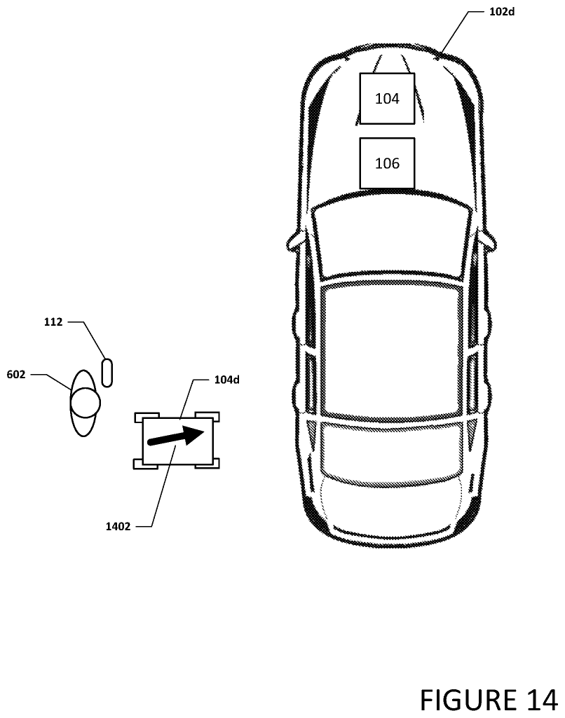

In an example, the AV assist drone 104c can deploy from the AV 102c and deliver a package 1304 to a destination 1306 and/or collect a package 1304 from the destination 1306. The destination may be a house, a building, a location designated by the recipient of the package 1304 or a location of the package 1304 if the package is to be picked up. More specifically, as illustrated in FIG. 14, the destination 1306 is a house. The package 1304 can be a container that includes goods, the goods themselves, or some other item or items that can be moved by the AV assist drone 104c from one location to another location. In some examples, the AV assist drone 104c can be stored in the delivery assembly 1302 with the package coupled to the AV assist drone 104c. The payload sensor 346 (not shown) can assist with the collection and delivery of the package 1304.

When the AV 102c reaches the delivery destination 1306 or a location that is relatively close to the delivery destination 1306, the AV assist drone 104c can deploy from the delivery assembly 1302 with the package 1304 and complete the delivery of the package 1304. In another example, the AV assist drone 104c deploys from the AV 102c, travels to the delivery assembly 1302 where the AV assist drone 104c collects the package from the delivery assembly 1302, and delvers the package 1304 to the destination 1306. In another example, in a package pickup mode, the AV assist drone 104c can deploy from the delivery assembly 1302, travel to the destination 1306 to retrieve the package 1304, and return to the delivery assembly 1302 with the package 1304. In yet another example, in a package pickup mode, the AV assist drone 104c can deploy from the AV 102c, travel to the destination 1306 to retrieve the package 1304, and return to the delivery assembly 1302 with the package 1304.

FIG. 14 illustrates an AV assist drone 104d deployed from an AV 102d in a user of an AV service assist mode according to some embodiments of the present disclosure. In an example, the AV assist drone 104d can deploy from the AV 102d and travel towards the user 602 of an AV service. In some examples, the user 602 has the user device 604. The AV assist drone 104d can be a terrestrial drone that is stored in an area under the AV 102d.

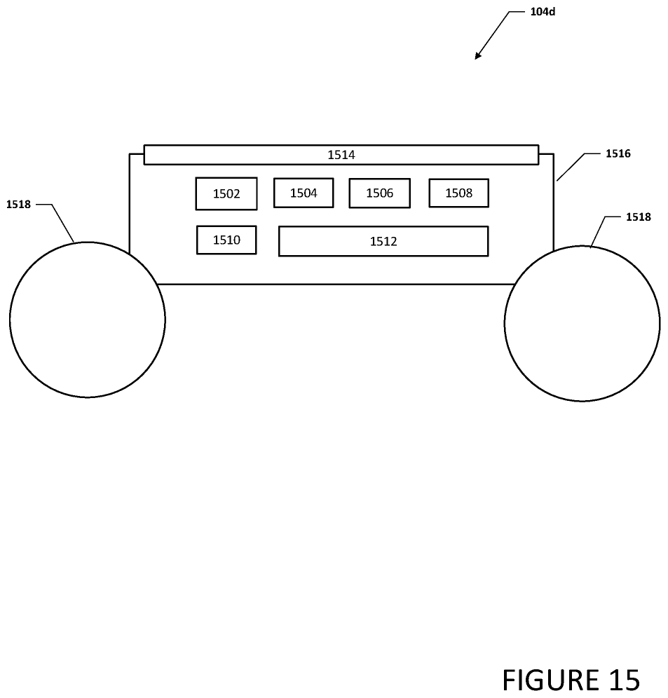

The AV assist drone 104d can authenticate the user 602 and guide the user 602 towards the AV 102d. In an example, the AV assist drone 104d authenticates the user 602 using one or more sensors in a drone sensor suite 1504 (illustrated in FIG. 15). More specifically, the one or more cameras 312, the one or more LIDAR 314, the one or more biometric sensors 332 or some other sensor may be used to authenticate the user 602. In another example, the AV assist drone 104d authenticates the user 602 through the user device 604. For example, the AV assist drone 104d can receive a validation code from the user device 604 or some other type of communication that can be used to authenticate the user 602 through the user device 604. In other examples, the user 602 is not authenticated by the AV assist drone 104d and the user is given a message or some type of prompt on the user device 604 to follow the AV assist drone 104d to the AV 102d.

The AV assist drone 104d can include a display panel (e.g., the display panel 5114 illustrated in FIG. 15) and the AV assist drone 104d can display a message 1402 on the display panel to the user 602 to guide the user 602 to the AV 102d. More specifically, as illustrated in FIG. 14, the message 1402 can be an arrow and the arrow can point in the direction of the AV 102d. In other examples, the message 1402 may be words such as “FOLLOW ME TO YOUR RIDE” or some other similar words or symbols that can guide the user 602 to the AV 102d. In some examples, the message 1402 may be personal to the user 602. For example, if the user's name is “Mo,” the message may be personalized for the user 602, “HI MO, PLEASE FOLLOW ME TO YOUR VEHICLE.”

FIG. 15 is a block diagram illustrating the AV assist drone 104d according to some embodiments of the present disclosure. The AV assist drone 104d can include a drone onboard controller 1502, a drone sensor suite 1504, a user guidance module 1506, user guidance devices 1508, a motor 1510, an onboard battery 1512, and a display panel 5114. The drone onboard controller 1502 can help the AV assist drone 104d identify objects in the environment around the AV assist drone 104d and navigate in the environment around the AV assist drone 104d. The drone onboard controller 1502 can be similar to the drone onboard controller 202 illustrated in FIG. 5. The drone sensor suite 1504 can include one or more sensors that can help the AV assist drone 104d identify objects and conditions in the environment around the AV assist drone 104d. The drone sensor suite 1504 may be similar to the drone sensor suite 204 illustrated in FIG. 3. The user guidance module 1506 can determine a path that can be used to guide or lead a user of an AV service associated with the AV 102d to the AV 102d. The user guidance devices 1508 can help provide some visual or audio guide for the user of the AV service associated with the AV 102 to help guide the user along a path to the AV 102d. In some examples, the user guidance module 1506 is similar to the user guidance module 206 illustrated in FIG. 4. The motor 1510 can help move or propel AV assist drone 104 during deployment of the AV assist drone 104d. The onboard battery 1512 can power the AV assist drone 104d. When the AV assist drone 104d is not deployed, the AV assist drone 104d can be coupled and/or secured to the AV 102d. In some examples, while the AV assist drone 104d is coupled and/or secured to the AV 102d, AV assist drone 104d can recharge the onboard battery 1512. The display panel 1514 can display messages or indicators (e.g., a directional indicator such as an arrow) to the user 602.

The AV assist drone 104d also includes a main body 1516 and a propulsion assembly 1518. For example, as illustrated in FIG. 15, the propulsion assembly 1518 includes a plurality of wheels. The motor 1510 can cause the wheels to rotate and control the motion of the AV assist drone 104d. The display panel 1514 can help to display the message 1402 (illustrated in FIG. 14) to the user 602 to guide the user 602 to the AV 102d. In the embodiment shown, the motor 1510 is an electric motor. However, in other embodiments, the motor 1510 may be a combustion engines or auxiliary power unit through a plurality of interconnect driveshafts and/or auxiliary gearboxes.

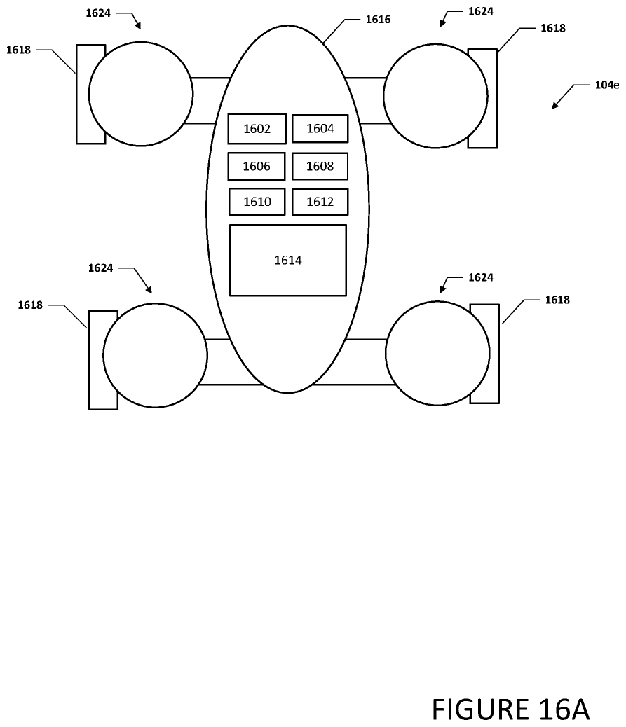

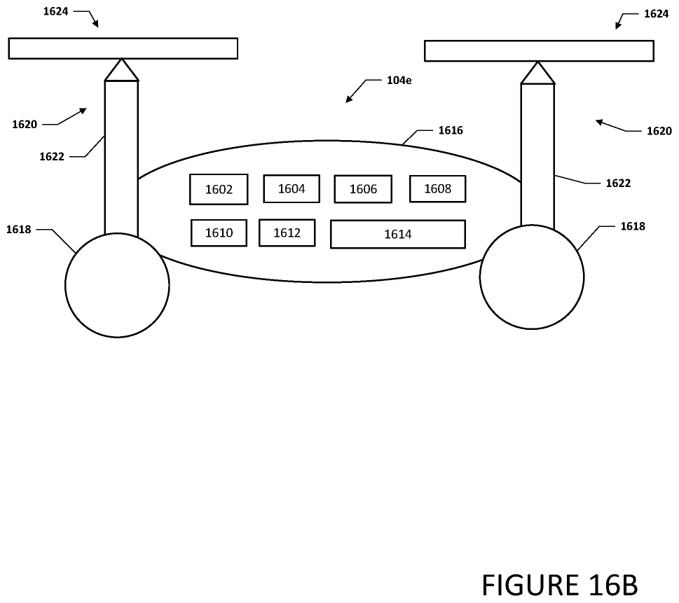

FIGS. 16A and 16B are block diagrams illustrating the AV assist drone 104e according to some embodiments of the present disclosure. FIG. 16A is a side view of the AV assist drone 104e and FIG. 16B is a top view of the AV assist drone 104e. The AV assist drone 104e can include a drone onboard controller 1602, a drone sensor suite 1604, a user guidance module 1606, user guidance devices 1608, a motor 1610, a flight controller 1612, and an onboard battery 1614. The drone onboard controller 1602 can help the AV assist drone 104e identify objects in the environment around the AV assist drone 104e and navigate in the environment around the AV assist drone 104e. The drone onboard controller 1602 can be similar to the drone onboard controller 202 illustrated in FIG. 5 and/or the drone onboard controller 1502 illustrated in FIG. 15. The drone sensor suite 1604 can include one or more sensors that can help the AV assist drone 104e identify objects and conditions in the environment around the AV assist drone 104e. The drone sensor suite 1604 may be similar to the drone sensor suite 204 illustrated in FIG. 3 and/or the drone sensor suite 1504 illustrated in FIG. 15. The user guidance module 1606 can determine a path that can be used to guide or lead a user of an AV service associated with the AV 102 to the AV 102 (not shown). The user guidance devices 1608 can help provide some visual or audio guide for the user of the AV service associated with the AV 102 to help guide the user along a path to the AV 102. In some examples, the user guidance module 1606 is similar to the user guidance module 206 illustrated in FIG. 4 and/or the user guidance module 1506 illustrated in FIG. 15. The motor 1610 can help move or propel AV assist drone 104e during deployment of the AV assist drone 104e. The flight controller 1612 can help enable the AV assist drone 104e to operate during flight. In some examples, the flight controller 1612 is the same or similar to the flight controller 210 illustrated in FIG. 2. The onboard battery 1614 can power the AV assist drone 104e. When the AV assist drone 104 is not deployed, the AV assist drone 104e can be coupled and/or secured to the AV 102. In some examples, while the AV assist drone 104e is coupled and/or secured to the AV 102, the AV assist drone 104e can recharge the onboard battery 1614.

The AV assist drone 104e also includes a main body 1616 and a terrestrial propulsion assembly 1618. For example, as illustrated in FIG. 16, the terrestrial propulsion assembly 1618 includes a plurality of wheels. When the AV assist drone 140e is deployed in a terrestrial mode, the motor 1610 can cause the wheels to rotate and control the motion of the AV assist drone 104e. In addition, the AV assist drone 104e includes a plurality of propulsion assemblies 1620 (illustrated in FIG. 16B). Each of the propulsion assemblies 1620 can include a blade motor 1622 and a plurality of rotor blades 1624. Each of the blade motors 1622 can be coupled to the motor 1610 and when the AV assist drone 140e is deployed in a flight mode, the motor 1610 can cause the blade motors 1622 to rotate the plurality of rotor blades 1624 and control the motion of the AV assist drone 104e.

The main body 1616 can help provides lift to the AV assist drone 104e during forward flight while also maintaining a relatively small footprint of the AV assist drone 104e. In the embodiment shown, the motor 1610 is an electric motor. However, in other embodiments, the motor 1610 may be a combustion engines or auxiliary power unit through a plurality of interconnect driveshafts and/or auxiliary gearboxes. In some examples, the main body 1616 can help to display a message to a user (e.g., the user 602) to guide the user to the AV 102.

Example Process

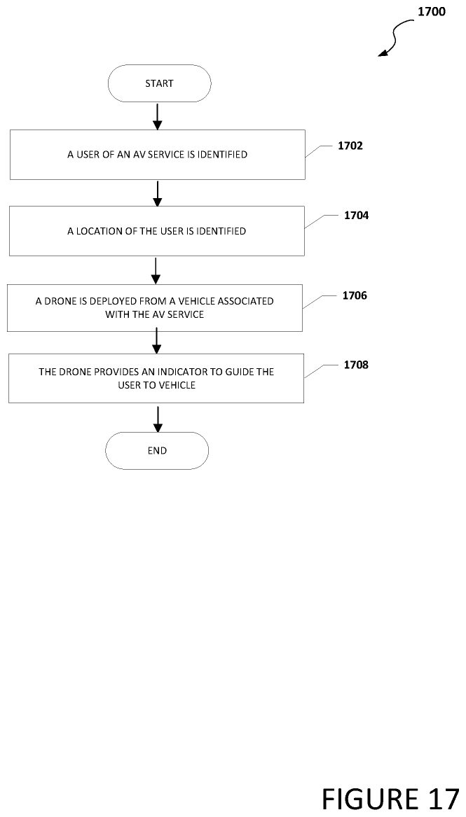

FIG. 17 is an example flowchart illustrating possible operations of a flow 1700 that may be associated with enabling a vehicle assist drone, in accordance with an embodiment. In an embodiment, one or more operations of flow 1700 may be performed by the AV 102, the AV assist drone 104, the AV onboard controller 106, and the drone onboard controller 202.

At 1702, a user of an AV service is identified. At 1704, a drone is deployed from a vehicle associated with the AV service. For example, the AV assist drone 104 can be deployed from the AV 102. At 1706, a location of the user is identified. For example, the AV assist drone 104 can use the drone onboard controller 202, or more specifically, the map data 402 and the localization module 406 to identify a location of the user. In another example, the AV 102 can communicate the location of the user to the AV assist drone 104. At 1708, the drone provides an indicator to guide the user to the vehicle. For example, the AV assist drone 104 can provide the indicator 606 to help guide the user to the AV 102.

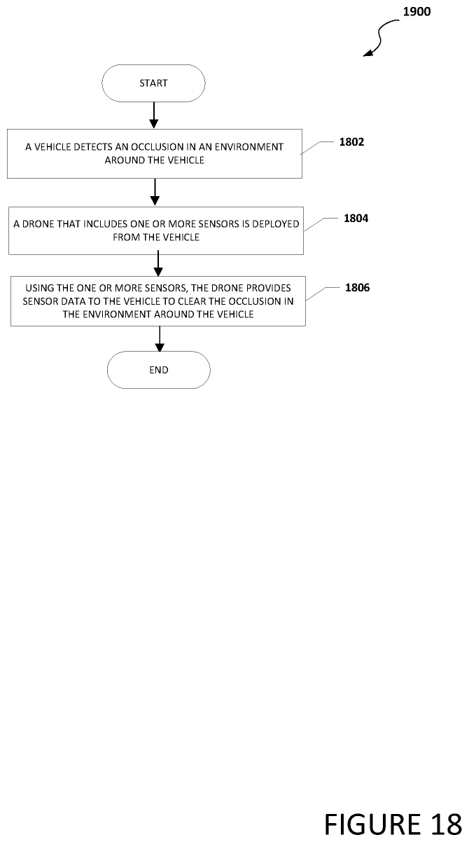

FIG. 18 is an example flowchart illustrating possible operations of a flow 1800 that may be associated with enabling a vehicle assist drone, in accordance with an embodiment. In an embodiment, one or more operations of flow 1800 may be performed by the AV 102, the AV assist drone 104, the AV onboard controller 106, and the drone onboard controller 202.

At 1802, a vehicle detects an occlusion in an environment around the vehicle. For example, using the AV sensor suite 108 the AV 102 can detect occlusions or areas that are blind to a sensor in the AV sensor suite 108. At 1804, a drone that includes one or more sensors is deployed from the vehicle. For example, the AV assist drone 104 can be deployed from the AV 102. At 1806, using the one or more sensors, the drone provides sensor data to the vehicle to clear the occlusion in the environment around the vehicle. For example, using the one or more sensors in the drone sensor suite 204, the drone can be deployed to the area that includes the occlusion and provide sensor data to the AV vehicle 102 to clear the occlusion in the environment around the AV vehicle 102.

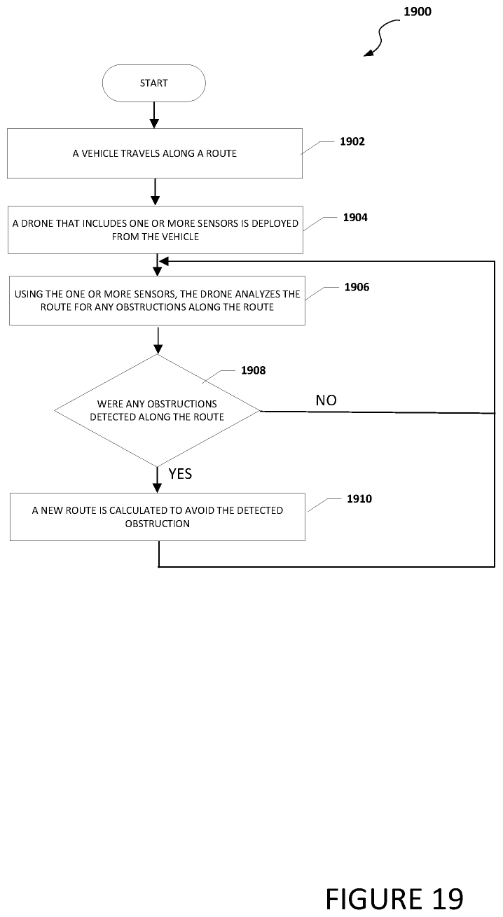

FIG. 19 is an example flowchart illustrating possible operations of a flow 1900 that may be associated with enabling a vehicle assist drone, in accordance with an embodiment. In an embodiment, one or more operations of flow 1900 may be performed by the AV 102, the AV assist drone 104, the AV onboard controller 106, and the drone onboard controller 202.

At 1902, a vehicle travels along a route. For example, the AV 102 may travel along a route. At 1904, a drone that includes one or more sensors is deployed from the vehicle. For example, the AV assist drone 104 can be deployed from the AV 102. At 1906, using the one or more sensors, the drone analyzes the route for any obstructions along the route. For example, the AV assist drone 104 can use the one or more sensors in the drone sensor suite 204 to analyze the route of the AV to identify any upcoming obstructions (e.g., a traffic jam, vehicle wreck, closed road, etc.). At 1908, the system determines if any obstructions were detected along the route. If there were no obstructions detected along the route, using the one or more sensors, the drone analyzes the route for any obstructions along the route, as in 1906. If there were obstructions detected along the route, a new route is calculated to avoid the detected obstruction, as in 1910 and, using the one or more sensors, the drone analyzes the (new) route for any obstructions along the route, as in 1906.

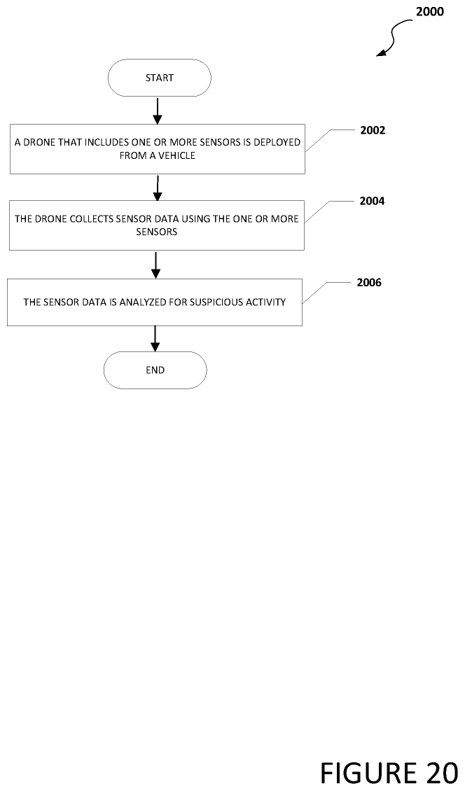

FIG. 20 is an example flowchart illustrating possible operations of a flow 2000 that may be associated with enabling a vehicle assist drone, in accordance with an embodiment. In an embodiment, one or more operations of flow 2000 may be performed by the AV 102, the AV assist drone 104, the AV onboard controller 106, and the drone onboard controller 202.

At 2002, a drone that includes one or more sensors is deployed from the vehicle. For example, the AV assist drone 104 can be deployed from the AV 102. At 2004, the drone collects sensor data using the one or more sensors. For example, the AV assist drone 104 can travel along a predetermined path and collect sensor data. At 2006, the sensor data is analyzed for suspicious activity. For example, the collected sensor data can be analyzed for illegal activity, a broken window in a car that may signal an attempted theft of the car, an open front door of a house that may indicate a break in, etc.

FIG. 21 is an example flowchart illustrating possible operations of a flow 2100 that may be associated with enabling a vehicle assist drone, in accordance with an embodiment. In an embodiment, one or more operations of flow 2100 may be performed by the AV 102, the AV assist drone 104, the AV onboard controller 106, and the drone onboard controller 202.

At 2102, a drone that includes one or more sensors is deployed from the vehicle. For example, the AV assist drone 104 can be deployed from the AV 102. At 2104, the drone collects sensor data in a predetermined area using the one or more sensors. For example, the AV assist drone 104 can be deployed in a predetermined area and collect sensor data or travel along a predetermined path and collect sensor data. At 2106, the sensor data is analyzed for the presence of identifying features or elements of a person or object. For example, using the one or more cameras 312 in the drone sensor suite 204, an area can be scanned for a missing child, a wanted criminal, a missing elderly person, a license plate of a child abductor, etc.

Example Autonomous Vehicle System

FIG. 22 shows an AV environment 2200 according to some embodiments of the present disclosure. The AV environment 2200 can include AVs 102, a fleet management system 2202, a client device 2204, and a user device 2206. Each of the AVs 102 can include the AV assist drone 104, the AV onboard controller 106, the AV sensor suite 108, and the AV assist drone housing 110. The AV onboard controller 106 controls the AV 102 and helps facilitate communication with the AV 102. The AV sensor suite 108 detects the environment inside and outside of the AV 102 and generates sensor data describing the surround environment.

Each of the AVs 102, the fleet management system 2202, the client device 2204, and/or the user device 2206 can be in communication using network 2208. In addition, each of the AVs 102, the fleet management system 2202, the client device 2204, and/or the user device 2206 can be in communication with one or more network elements 2210, one or more servers 2212, and cloud services 2214 using the network 2208. In other embodiments, the AV environment 2200 may include fewer, more, or different components. For example, the AV environment 2200 may include a different number of AVs 102 with some AVs 102 including the AV onboard controller 106 and some AVs 102 not including the AV onboard controller 106 (not shown). A single AV is referred to herein as AV 102, and multiple AVs are referred to collectively as AVs 102. For purpose of simplicity and illustration, FIG. 23 shows one client device 2204 and one user device 2206. In other embodiments, the AV environment 2200 includes multiple third-party devices or multiple client devices.

In some embodiments, the AV environment 2200 includes one or more communication networks (e.g., network 2208) that supports communications between some or all of the components in the AV environment 2200. The network 2208 may comprise any combination of local area and/or wide area networks, using both wired and/or wireless communication systems. In one embodiment, the network uses standard communications technologies and/or protocols. For example, the network 2208 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 2208 may be represented using any suitable format, such as hypertext markup language (HTML) or extensible markup language (XML). In some embodiments, all or some of the communication links of the network 2208 may be encrypted using any suitable technique or techniques.

In some embodiments, an AV 102 includes the AV onboard controller 106 (illustrated in FIG. 5) and the AV sensor suite 108. The AV sensor suite 108 can include a computer vision (“CV”) system, localization sensors, and driving sensors. For example, the AV sensor suite 108 may include interior and exterior cameras, radar sensors, sonar sensors, light detection and ranging (LIDAR) sensors, thermal sensors, wheel speed sensors, inertial measurement units (IMUS), accelerometers, microphones, strain gauges, pressure monitors, barometers, thermometers, altimeters, ambient light sensors, etc. The sensors may be located in various positions in and around the AV 102. For example, the AV 102 may have multiple cameras located at different positions around the exterior and/or interior of the AV 102.

An AV 102 may also include a rechargeable battery that powers the AV 102. The battery may be a lithium-ion battery, a lithium polymer battery, a lead-acid battery, a nickel-metal hydride battery, a sodium nickel chloride (“zebra”) battery, a lithium-titanate battery, or another type of rechargeable battery. In some embodiments, the AV 102 is a hybrid electric vehicle that also includes an internal combustion engine for powering the AV 102 (e.g., when the battery has low charge). In some embodiments, the AV 102 includes multiple batteries. For example, the AV 102 can include a first battery used to power vehicle propulsion, and a second battery used to power the AV onboard controller 106 and/or AV hardware (e.g., the AV sensor suite 108 and the AV onboard controller 106). The AV 102 may further include components for charging the battery (e.g., a charge port configured to make an electrical connection between the battery and a charging station).

The fleet management system 2202 manages AV services using the AVs 102. In one example, the AV service is a ridehail/rideshare service where users are picked up and dropped off in a vehicle (AV 102). The AV service is typically arranged using a website or app.

The fleet management system 2202 may select an AV 102 from a fleet of AVs 102 to perform a particular AV service (e.g., ridehail, rideshare, and/or other tasks) and instruct the selected AV 102 to autonomously drive to a particular location (e.g., an address to pick up a user). The fleet management system 2202 sends an AV service request to the AV 102 and if the AV assist drone 104 is deployed, to the AV assist drone 104. The AV service request includes information associate with the AV service, information of a user requesting the AV service (e.g., location, identifying information, etc.), information of a user to be picked up, etc. In some embodiments, the fleet management system 2202 may instruct one single AV 102 to perform multiple AV services. For example, the fleet management system 2202 instructs the AV 102 to pick up riders and/or items from one location and deliver the riders and/or items to multiple locations, or vice versa. The fleet management system 2202 also manages maintenance tasks, such as charging and servicing of the AVs 102 a and the AV assist drone 104. As shown in FIG. 22, each of the AVs 102 communicates with the fleet management system 2202. The AVs 102 and fleet management system 2202 may connect over a public network, such as the Internet. The fleet management system 2202 is described further in relation to FIG. 23.

In some embodiments, the fleet management system 2202 may also provide the AV 102 (and particularly, AV onboard controller 106) and the AV assist drone 104 with system backend functions. The fleet management system 2202 may include one or more switches, servers, databases, live advisors, or an automated voice response system (VRS). The fleet management system 2202 may include any or all of the aforementioned components, which may be coupled to one another via a wired or wireless local area network (LAN). The fleet management system 2202 may receive and transmit data via one or more appropriate devices and network from and to the AV 102 and the AV assist drone 104, such as by wireless systems, such as 882.11x, general packet radio service (GPRS), and the like. A database at the fleet management system 2202 can store account information such as subscriber authentication information, vehicle identifiers, profile records, behavioral patterns, and other pertinent subscriber information. The fleet management system 2202 may also include a database of roads, routes, locations, etc. permitted for use by AV 102 and the AV assist drone 104. The fleet management system 2202 may communicate with the AV 102 and the AV assist drone 104 to provide route guidance in response to a request received from the vehicle.

For example, based upon information stored in a mapping system of the fleet management system 2202, the fleet management system 2202 may determine the conditions of various roads or portions thereof. Autonomous vehicles, such as the AV 102, may, in the course of determining a navigation route, receive instructions from the fleet management system 2202 regarding which roads or portions thereof, if any, are appropriate for use under certain circumstances, as described herein. Such instructions may be based in part on information received from the AV 102 or other autonomous vehicles regarding road conditions. Accordingly, the fleet management system 2202 may receive information regarding the roads/routes generally in real-time from one or more vehicles.

The fleet management system 2202 communicates with the client device 2204. For example, the fleet management system 2202 receives AV service requests from the client device 2204. The AV service request may include information of the user to be picked up, information of one or more items to be picked up, information of the location for the pick up (e.g., store location, distribution center location, warehouse location, location of a customer, etc.), and so on. The fleet management system 2202 can provide information associated with the AV service request (e.g., information related to the identity of the user to be picked up, information of the status of the AV service process, etc.) to the client device 2204.

The client device 2204 may be a device (e.g., a computer system) of a user of the fleet management system 2202. The user may be an entity or an individual. In some embodiments, a user may be a customer of another user. In an embodiment, the client device 2204 is an online system maintained by a business (e.g., a retail business, a AV service business, a package service business, etc.). The client device 2204 may be an application provider communicating information describing applications for execution by the user device 2206 or communicating data to the user device 2206 for use by an application executing on the user device 2206.

The user device 2206 may the same as or similar to the user device 604. The user device 2206 is one or more computing devices capable of receiving user input as well as transmitting and/or receiving data via the network. The user device 2206 may be a device of an individual. The user device 2206 communicates with the client device 2204 to request use of the AV 102. For example, the user device 2206 may send an AV service request or user pick up request to the client device 2204 through an application executed on the user device 2206. The user device 2206 may receive from the client device 2204 information associated with the request, such as the identity of the user to be picked up, a status of an AV service process, etc. In one embodiment, the user device 2206 is a conventional computer system, such as a desktop or a laptop computer. Alternatively, a user device 2206 may be a device having computer functionality, such as a personal digital assistant (PDA), a mobile telephone, a smartphone, or another suitable device. A user device 2206 is configured to communicate via the network. In one embodiment, a user device 2206 executes an application allowing a user of the user device 2206 to interact with the fleet management system 2202. For example, a user device 2206 executes a browser application to enable interaction between the user device 2206 and the fleet management system 2202 via the network. In another embodiment, a user device 2206 interacts with the fleet management system 2202 through an application programming interface (API) running on a native operating system of the user device 2206, such as IOS® or ANDROID™

Example Online System

FIG. 23 is a block diagram illustrating the fleet management system 2202 according to some embodiments of the present disclosure. The fleet management system 2202 can include a user device interface 2302, a vehicle manager 2304, user ride data 2306, map data 2308, and user interest data 2310. Each of the user ride data 2306, the map data 2308, and the user interest data 2310 can be located in one or more data stores. In some examples, the one or more data stores are one or more databases. The user device interface 2302 includes a ride request interface 2312 and user settings interface 2314. The vehicle manager 2304 includes a vehicle dispatcher 2316 and an AV interface 2318. Alternative configurations, different or additional components may be included in the fleet management system 2202. Further, functionality attributed to one component of the fleet management system 2202 may be accomplished by a different component included in the fleet management system 2202 or a different system (e.g., the onboard controller of an AV 102).

The user device interface 2302 is configured to communicate with third-party devices (e.g., the user device 2206) that provide a UI to users. For example, the user device interface 2302 may be a web server that provides a browser-based application to third-party devices, or the user device interface 2302 may be a mobile app server that interfaces with a mobile app installed on third-party devices. For example, the user device interface 2302 may provide one or more apps or browser-based interfaces that can be accessed by users, such as the users using user device 2206. The user device interface 2302 includes the ride request interface 2312, that enables the users to submit requests to a ride service provided or enabled by the fleet management system 2202. The user device interface 2302 further includes the user settings interface 2314 that the user can use to select ride settings. The user settings interface 2314 may enable the user to opt-in to some, all, or none of the options offered by the ride service provider. The user settings interface 2314 may further enable the user to opt-in to certain user device resource usage features (e.g., to opt-in to allow the AV to access the camera on the user device to obtain supplemental image data). The user settings interface 2314 may explain how this data is used and may enable users to selectively opt-in to certain user device resource usage features, or to opt-out of all of the user device resource usage features.

The user ride data 2306 stores ride information associated with users of the ride service. The user ride data 2306 may include an origin location and a destination location for a user's current ride. The map data 450 stores a detailed map of environments through which the AVs 102 may travel. The map data 2308 includes data describing roadways, (e.g., locations of roadways, connections between roadways, roadway names, speed limits, traffic flow regulations, toll information, etc.). The user interest data 2310 stores data indicating user interests. For example, a learning module may compare locations in the user ride data 2306 with map data 2308 to identify places the user has visited or plans to visit.

The vehicle manager 2304 manages and communicates with a fleet of AVs (e.g., the AVs 102). The vehicle manager 2304 may assign AVs 102 to various tasks and direct the movements of the AVs 102 in the fleet. The vehicle manager 2304 includes the vehicle dispatcher 2316 and the AV interface 2318. The vehicle dispatcher 2316 selects AVs from the fleet to perform various tasks and instructs the AVs to perform the tasks. For example, the vehicle dispatcher 2316 receives a ride request from the ride request interface 2312. The vehicle dispatcher 2316 selects an AV 102 to service the ride request based on the information provided in the ride request, (e.g., the origin and destination locations).

The AV interface 2318 interfaces with the AVs 102, and in particular, with the AV onboard controller 106 of the AVs 102. The AV interface 2318 allows for bi-directional wireless communication between the fleet management system 2202 and AVs 102. The AV interface 2318 may receive sensor data from the AVs 102, such as camera images, captured sound, and other outputs from the AV sensor suite 108.

Other Implementation Notes, Variations, and Applications

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of the embodiment, examples, and/or operations disclosed herein may be implemented using one or more electrical circuits on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurations (e.g., programmable) elements arranged in a structure that supports these functions. The software or firmware providing the emulation may be provided on non-transitory computer-readable storage medium comprising instructions to allow a processor to carry out those functionalities.

Additionally, one or more of the AV 102, the AV onboard controller 106, the AV sensor suite 108, the fleet management system 2202, and the user device 2206 may include one or more processors that can execute software, logic, or an algorithm to perform activities as discussed herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read-only memory (EPROM), an electrically erasable programmable read-only memory (EEPROM)) or an application specific integrated circuit (ASIC) that includes digital logic, software, code, electronic instructions, or any suitable combination thereof. Any of the potential processing elements, modules, and machines described herein should be construed as being encompassed within the broad term ‘processor.’

Implementations of the embodiments disclosed herein may be formed or carried out on a substrate, such as a non-semiconductor substrate or a semiconductor substrate. In one implementation, the non-semiconductor substrate may be silicon dioxide, an inter-layer dielectric composed of silicon dioxide, silicon nitride, titanium oxide and other transition metal oxides. Although a few examples of materials from which the non-semiconducting substrate may be formed are described here, any material that may serve as a foundation upon which a non-semiconductor device may be built falls within the spirit and scope of the embodiments disclosed herein.

In another implementation, the semiconductor substrate may be a crystalline substrate formed using a bulk silicon or a silicon-on-insulator substructure. In other implementations, the semiconductor substrate may be formed using alternate materials, which may or may not be combined with silicon, that include but are not limited to germanium, indium antimonide, lead telluride, indium arsenide, indium phosphide, gallium arsenide, indium gallium arsenide, gallium antimonide, or other combinations of group III-V or group IV materials. In other examples, the substrate may be a flexible substrate including 2D materials such as graphene and molybdenum disulphide, organic materials such as pentacene, transparent oxides such as indium gallium zinc oxide poly/amorphous (low temperature of dep) III-V semiconductors and germanium/silicon, and other non-silicon flexible substrates. Although a few examples of materials from which the substrate may be formed are described here, any material that may serve as a foundation upon which a semiconductor device may be built falls within the spirit and scope of the embodiments disclosed herein.

Each of the AV 102, the AV onboard controller 106, the AV sensor suite 108, the fleet management system 2202, and the user device 2206 may include any suitable hardware, software, components, modules, or objects that facilitate the operations thereof, as well as suitable interfaces for receiving, transmitting, and/or otherwise communicating data or information in a network environment. This may be inclusive of appropriate algorithms and communication protocols that allow for the effective exchange of data or information.

Each of the AV 102, the AV onboard controller 106, the AV sensor suite 108, the fleet management system 2202, and the user device 2206 can include memory elements for storing information to be used in the operations outlined herein. The AV 102, the AV onboard controller 106, the AV sensor suite 108, the fleet management system 2202, and the user device 2206 may keep information in any suitable memory element (e.g., random access memory (RAM), read-only memory (ROM), erasable programmable ROM (EPROM), electrically erasable programmable ROM (EEPROM), ASIC, etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in the AV 102, the AV onboard controller 106, the AV sensor suite 108, the fleet management system 2202, and the user device 2206 could be provided in any database, register, queue, table, cache, control list, or other storage structure, all of which can be referenced at any suitable timeframe. Any such storage options may also be included within the broad term ‘memory element’ as used herein.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media. In some of these examples, memory elements can store data used for the operations described herein. This includes the memory elements being able to store software, logic, code, or processor instructions that are executed to carry out the activities described herein.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular arrangements of components. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more components. However, this has been done for purposes of clarity and example only. It should be appreciated that the system can be consolidated in any suitable manner. Along similar design alternatives, any of the illustrated components, modules, and elements of the FIGURES may be combined in various possible configurations, all of which are clearly within the broad scope of this Specification.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of the systems and methods described above may also be implemented with respect to the methods or systems described herein and specifics in the examples may be used anywhere in one or more embodiments.

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph (f) of 35 U.S.C. Section 112 as it exists on the date of the filing hereof unless the words “means for” or “step for” are specifically used in the particular claims; and (b) does not intend, by any statement in the Specification, to limit this disclosure in any way that is not otherwise reflected in the appended claims.

### OTHER NOTES AND EXAMPLES

Example M1 is a method for guiding a user of an AV service to a vehicle associated with the AV service, the method including deploying a vehicle assist drone to a location of the user of the AV service and providing an indicator to guide to the user of the AV service to the vehicle.

In Example M2, the subject matter of Example M1 can optionally include where the indicator is an arrow or line.

In Example M3, the subject matter of Example M1 can optionally include where the indicator is a sound.

In Example M4, the subject matter of Example M1 can optionally include where the vehicle includes a vehicle assist drone housing.

In Example M5, the subject matter of Example M1 can optionally include where the vehicle assist drone housing can recharge a battery in the vehicle assist drone when the vehicle assist drone is coupled to the vehicle assist drone housing.

In Example, M6, the subject matter of Example M1 can optionally include where the battery is recharged wirelessly.

In Example, M7, the subject matter of Example M1 can optionally include where the vehicle assist drone housing secures the vehicle assist drone to the vehicle assist drone housing using magnets.

In Example, M8, the subject matter of Example M1 can optionally include where the vehicle assist drone authenticates the user using facial recognition.

In Example, M9, the subject matter of Example M1 can optionally where the vehicle assist drone authenticates the user through communication with a user device associated with the user.

In Example, M10, the subject matter of Example M1 can optionally include where the user device is a smart phone.

In Example, M11, the subject matter of Example M1 can optionally include where the vehicle assist drone is an aerial drone.

In Example, M12, the subject matter of Example M1 can optionally include where the guide is an arrow or line that is projected on the ground by the vehicle assist drone.

In Example, M13, the subject matter of Example M1 can optionally include where the vehicle assist drone is a terrestrial drone.

In Example, M14, the subject matter of Example M1 can optionally include where the vehicle assist drone is a hybrid aerial/terrestrial drone.

In Example, M15, the subject matter of Example M1 can optionally include where the vehicle is an autonomous vehicle.

In Example, M16, the subject matter of Example M1 can optionally include where the vehicle assist drone is an autonomous drone that navigates without navigation instructions from the vehicle.

In Example M17, the subject matter of any of Examples M1-M2 can optionally include where the indicator is a sound.

In Example M18, the subject matter of any of Examples M1-M3 can optionally include where the vehicle includes a vehicle assist drone housing.

In Example M19, the subject matter of any of Examples M1-M4 can optionally include where the vehicle assist drone housing can recharge a battery in the vehicle assist drone when the vehicle assist drone is coupled to the vehicle assist drone housing.

In Example, M20, the subject matter of any of Examples M1-M5 can optionally include where the battery is recharged wirelessly.

In Example, M21, the subject matter of any of Examples M1-M6 can optionally include where the vehicle assist drone housing secures the vehicle assist drone to the vehicle assist drone housing using magnets.

In Example, M22, the subject matter of any of Examples M1-M7 can optionally include where the vehicle assist drone authenticates the user using facial recognition.

In Example, M23, the subject matter of any of Examples M1-M8 can optionally where the vehicle assist drone authenticates the user through communication with a user device associated with the user.

In Example, M24, the subject matter of any of the Examples M1-M9 can optionally include where the user device is a smart phone.

In Example, M25, the subject matter of any of the Examples M1-M10 can optionally include where the vehicle assist drone is an aerial drone.

In Example, M26, the subject matter of any of the Examples M1-M11 can optionally include where the guide is an arrow or line that is projected on the ground by the vehicle assist drone.

In Example, M27, the subject matter of any of the Examples M1-M12 can optionally include where the vehicle assist drone is a terrestrial drone.

In Example, M28, the subject matter of any of the Examples M1-M13 can optionally include where the vehicle assist drone is a hybrid aerial/terrestrial drone.

In Example, M29, the subject matter of any of the Examples M1-M14 can optionally include where the vehicle is an autonomous vehicle.

In Example, M30, the subject matter of any of the Examples M1-M15 can optionally include where the vehicle assist drone is an autonomous drone that navigates without navigation instructions from the vehicle.

Example MM1 is a method for clearing one or more occlusions in an environment around a vehicle, the method including deploying a vehicle assist drone from the vehicle, wherein the vehicle assist drone includes one or more sensors and is in communication with the vehicle, causing the one or more sensors on the vehicle assist drone to collect sensor data related to the environment around the vehicle, and receiving the collected sensor data from the vehicle assist drone, wherein the collected sensor data is used to clear one or more occlusions in the environment around the vehicle.

In Example MM2, the subject matter of Example MM1 can optionally include where the one or more sensors include a camera.

In Example MM3, the subject matter of Example MM1 can optionally include where the one or more sensors include a light detection and ranging sensor.

In Example MM4, the subject matter of Example MM1 can optionally include where the one or more sensors include a time-of-flight sensor.

In Example MM5, the subject matter of any of Example MM1 can optionally include where before being deployed from the vehicle, the vehicle assist drone is secured to a vehicle assist drone housing on the vehicle.

In Example, MM6, the subject matter of Example MM1 can optionally include where the vehicle assist drone housing can recharge a battery in the vehicle assist drone when the vehicle assist drone is coupled to the vehicle assist drone housing.

In Example, MM7, the subject matter of Example MM1 can optionally include where the battery is recharged wirelessly.

In Example, MM8, the subject matter of Example MM1 can optionally include where the vehicle assist drone is an autonomous drone that autonomously collects the sensor data related to the environment around the vehicle.

In Example, MM9, the subject matter of Example MM1 can optionally include where the vehicle communicates a location of the one or more occlusions to the vehicle assist drone.

In Example, MM10, the subject matter of Example MM1 can optionally include where the vehicle controls navigation and sensor data collection of the vehicle assist drone.

In Example, MM11, the subject matter of Example MM1 can optionally include where the vehicle assist drone is an aerial drone.

In Example, MM12, the subject matter of Example MM1 can optionally include where the vehicle is an autonomous vehicle.

In Example MM13, the subject matter of any of the Examples MM1-MM2 can optionally include where the one or more sensors include a light detection and ranging sensor.

In Example MM14, the subject matter of any of the Examples MM1-MM3 can optionally include where the one or more sensors include a time-of-flight sensor.

In Example MM15, the subject matter of any of the Examples MM1-MM4 can optionally include where before being deployed from the vehicle, the vehicle assist drone is secured to a vehicle assist drone housing on the vehicle.

In Example, MM16, the subject matter of any of the Examples MM1-MM5 can 6optionally include where the vehicle assist drone housing can recharge a battery in the vehicle assist drone when the vehicle assist drone is coupled to the vehicle assist drone housing.

In Example, MM17, the subject matter of any of the Examples MM1-MM6 can optionally include where the battery is recharged wirelessly.

In Example, MM18, the subject matter of any of the Examples MM1-MM7 can optionally include where the vehicle assist drone is an autonomous drone that autonomously collects the sensor data related to the environment around the vehicle.

In Example, MM19, the subject matter of any of the Examples MM1-MM8 can optionally include where the vehicle communicates a location of the one or more occlusions to the vehicle assist drone.

In Example, MM20, the subject matter of any of the Examples MM1-MM9 can optionally include where the vehicle controls navigation and sensor data collection of the vehicle assist drone.

In Example, MM21, the subject matter of any of the Examples MM1-MM10 can optionally include where the vehicle assist drone is an aerial drone.

In Example, MM22, the subject matter of any of the Examples MM1-MM11 can optionally include where the vehicle is an autonomous vehicle.

Example A1, is a vehicle assist drone for supplementing vehicle sensor data of a vehicle with-supplemental sensor data from one or more sensors on the vehicle assist drone, the vehicle assist drone including a main body, a propulsion assembly, a sensor suite including one or more sensors to sense an environment and generate sensor data, a perception system to receive the sensor data and to acquire map data and to use the map data and the sensor data to generate vehicle assist drone real world environment data, and a vehicle interface module to communicate with the vehicle.

In Example A2, the subject matter of Example A1 can optionally include a user guidance module to provide an indicator to guide to a user of an AV service to the vehicle.

In Example A3, the subject matter of Example A2 can optionally include where the indicator is an arrow or line.

In Example A4, the subject matter of Example A3 can optionally include where the indicator is a sound.

In Example A5, the subject matter of Example A1 can optionally include where the vehicle assist drone is a terrestrial drone and the propulsion assembly includes a plurality of wheels.

In Example A6, the subject matter of Example A1 can optionally include where the vehicle assist drone real world environment data is used to clear one or more occlusions in sensor data of the vehicle related to the environment around the vehicle.

In Example A7, the subject matter of Example A1 can optionally include where the one or more sensors include a camera.

In Example A8, the subject matter of Example A1 can optionally include where the one or more sensors include a light detection and ranging sensor.

In Example A9, the subject matter of Example A1 can optionally include where the one or more sensors include a time-of-flight sensor.

In Example A10, the subject matter of Example A1 can optionally include where the vehicle assist drone real world environment data is used to identify upcoming obstacles along a route of the vehicle.

In Example A11, the subject matter of Example A1 can optionally include where a new route of the vehicle is determined based on identification of upcoming obstacles along the route of the vehicle.

In Example A12, the subject matter of Example A1 can optionally include a rechargeable battery.

In Example A13, the subject matter of Example A1 can optionally include where the battery is recharged when the vehicle assist drone is coupled to the vehicle.

In Example A14, the subject matter of Example A1 can optionally include where the vehicle assist drone is an aerial drone and the propulsion assembly includes a motor and rotor blades.

In Example A15, the subject matter of Example A1 can optionally include where the vehicle is an autonomous vehicle.

In Example A16, the subject matter of any of Examples A1-A2 can optionally include where the indicator is an arrow or line.

In Example A17, the subject matter of any of Examples A1-A3 can optionally include where the indicator is a sound.

In Example A18, the subject matter of any of Examples A1-A4 can optionally include where the vehicle assist drone is a terrestrial drone and the propulsion assembly includes a plurality of wheels.

In Example A19, the subject matter of any of Examples A1-A5 can optionally include where the vehicle assist drone real world environment data is used to clear one or more occlusions in sensor data of the vehicle related to the environment around the vehicle.

In Example A20, the subject matter of any of Examples A1-A6 can optionally include where the one or more sensors include a camera.

In Example A21, the subject matter of any of Examples A1-A7 can optionally include where the one or more sensors include a light detection and ranging sensor.

In Example A22, the subject matter of any of Examples A1-A8 can optionally include where the one or more sensors include a time-of-flight sensor.

In Example A23, the subject matter of any of Examples A1-A9 can optionally include where the vehicle assist drone real world environment data is used to identify upcoming obstacles along a route of the vehicle.

In Example A24, the subject matter of any of Examples A1-A10 can optionally include where a new route of the vehicle is determined based on identification of upcoming obstacles along the route of the vehicle.

In Example A25, the subject matter of any of Examples A1-A11 can optionally include a rechargeable battery.

In Example A26, the subject matter of any of Examples A1-A12 can optionally include where the battery is recharged when the vehicle assist drone is coupled to the vehicle.

In Example A27, the subject matter of any of Examples A1-A13 can optionally include where the vehicle assist drone is an aerial drone and the propulsion assembly includes a motor and rotor blades.

In Example A28, the subject matter of any of Examples A1-A14 can optionally include where the vehicle is an autonomous vehicle.

Example AA1 is a device including at least one machine-readable medium comprising one or more instructions that, when executed by at least one processor, causes the at least one processor to deploy a vehicle assist drone to a location of the user of the AV service and provide an indicator to guide to the user of the AV service to the vehicle.

In Example AA2, the subject matter of Example AA1 can optionally include where the indicator is an arrow or line.

In Example AA3, the subject matter of Example AA2 can optionally include where the indicator is a sound.

In Example AA4, the subject matter of Example AA1 can optionally include where the vehicle includes a vehicle assist drone housing.

In Example AA5, the subject matter of Example AA1 can optionally include where the vehicle assist drone housing can recharge a battery in the vehicle assist drone when the vehicle assist drone is coupled to the vehicle assist drone housing.

In Example AA6, the subject matter of Example AA1 can optionally include where the battery is recharged wirelessly.

In Example AA7, the subject matter of Example AA1 can optionally include where the vehicle assist drone housing secures the vehicle assist drone to the vehicle assist drone housing using magnets.

In Example AA8, the subject matter of Example AA1 can optionally include where the vehicle assist drone authenticates the user using facial recognition.

In Example AA9, the subject matter of Example AA1 can optionally include where the vehicle assist drone authenticates the user through communication with a user device associated with the user.

In Example AA10, the subject matter of Example AA1 can optionally include where the user device is a smart phone.

In Example AA11, the subject matter of Example AA1 can optionally include where the vehicle assist drone is an aerial drone.

In Example AA12, the subject matter of Example AA1 can optionally include where the guide is an arrow or line that is projected on the ground by the vehicle assist drone.

In Example AA13, the subject matter of Example AA1 can optionally include where the vehicle assist drone is a terrestrial drone.

In Example AA14, the subject matter of Example AA1 can optionally include where the vehicle assist drone is a hybrid aerial/terrestrial drone.

In Example AA15, the subject matter of Example AA1 can optionally include where the vehicle is an autonomous vehicle.

In Example AA16, the subject matter of Example AA1 can optionally include where the vehicle assist drone is an autonomous drone that navigates without navigation instructions from the vehicle.

In Example AA17, the subject matter of any of Examples AA1-AA2 can optionally include where the indicator is a sound.

In Example AA18, the subject matter of any of Examples AA1-AA3 can optionally include where the vehicle includes a vehicle assist drone housing.

In Example AA19, the subject matter of any of Examples AA1-AA4 can optionally include where the vehicle assist drone housing can recharge a battery in the vehicle assist drone when the vehicle assist drone is coupled to the vehicle assist drone housing.

In Example AA20, the subject matter of any of Examples AA1-AA5 can optionally include where the battery is recharged wirelessly.

In Example AA21, the subject matter of any of Examples AA1-AA6 can optionally include where the vehicle assist drone housing secures the vehicle assist drone to the vehicle assist drone housing using magnets.

In Example AA22, the subject matter of any of Examples AA1-AA7 can optionally include where the vehicle assist drone authenticates the user using facial recognition.

In Example AA23, the subject matter of any of Examples AA1-AA8 can optionally include where the vehicle assist drone authenticates the user through communication with a user device associated with the user.

In Example AA24, the subject matter of any of Examples AA1-AA9 can optionally include where the user device is a smart phone.

In Example AA25, the subject matter of any of Examples AA1-AA10 can optionally include where the vehicle assist drone is an aerial drone.

In Example AA26, the subject matter of any of Examples AA1-AA11 can optionally include where the guide is an arrow or line that is projected on the ground by the vehicle assist drone.

In Example AA27, the subject matter of any of Examples AA1-AA12 can optionally include where the vehicle assist drone is a terrestrial drone.

In Example AA28, the subject matter of any of Examples AA1-AA13 can optionally include where the vehicle assist drone is a hybrid aerial/terrestrial drone.

In Example AA29, the subject matter of any of Examples AA1-AA14 can optionally include where the vehicle is an autonomous vehicle.

In Example AA30, the subject matter of any of Examples AA1-AA15 can optionally include where the vehicle assist drone is an autonomous drone that navigates without navigation instructions from the vehicle.

Example MMM1 is a method for refining a route of a vehicle, the method including collecting sensor data related to the route of the vehicle using one or more sensors on a vehicle assist drone and analyzing the collected sensor data to identify one or more obstructions along the route.

In Example MMM2, the subject matter of Example MMM1 can optionally include creating a new route for the vehicle based on identified one or more obstructions along the route.

In Example MMM3, the subject matter of Example MMM1 can optionally include where the identified one or more obstructions includes a traffic jam and/or a vehicle accident that has occurred along the route.

In Example MMM4, the subject matter of Example MMM1 can optionally include where the one or more sensors include a camera.

In Example MMM5, the subject matter of any of Example MMM1 can optionally include where the one or more sensors include a light detection and ranging sensor.

In Example, MMM6, the subject matter of Example MMM1 can optionally include where the one or more sensors include a time-of-flight sensor.

In Example, MMM7, the subject matter of Example MMM1 can optionally include where before being deployed from the vehicle to collect the sensor data related to the route of the vehicle, the vehicle assist drone is secured to a vehicle assist drone housing on the vehicle.

In Example, MMM8, the subject matter of Example MMM1 can optionally include where the vehicle assist drone housing can recharge a battery in the vehicle assist drone when the vehicle assist drone is coupled to the vehicle assist drone housing.

In Example, MMM9, the subject matter of Example MMM1 can optionally include where the battery is recharged wirelessly.

In Example, MMM10, the subject matter of Example MMM1 can optionally include where the vehicle assist drone is an autonomous drone that autonomously collects the sensor data related to an environment around the vehicle.

In Example, MMM11, the subject matter of Example MMM1 can optionally include where the vehicle controls navigation and sensor data collection of the vehicle assist drone.

In Example, MMM12, the subject matter of Example MMM1 can optionally include where the vehicle assist drone is an aerial drone.

In Example, MMM13, the subject matter of Example MMM1 can optionally include where the vehicle is an autonomous vehicle.

In Example MMM14, the subject matter of any of the Examples MMM1-MMM2 can optionally include where the identified one or more obstructions includes a traffic jam and/or a vehicle accident that has occurred along the route.

In Example MMM15, the subject matter of any of the Examples MMM1-MMM3 can optionally include where the one or more sensors include a camera.

In Example MMM16, the subject matter of any of the Examples MMM1-MMM4 can optionally include where the one or more sensors include a light detection and ranging sensor.

In Example, MMM17, the subject matter of any of the Examples MMM1-MMM5 can 6optionally include where the one or more sensors include a time-of-flight sensor.

In Example, MMM18, the subject matter of any of the Examples MMM1-MMM6 can 7optionally include where before being deployed from the vehicle to collect the sensor data related to the route of the vehicle, the vehicle assist drone is secured to a vehicle assist drone housing on the vehicle.

In Example, MMM19, the subject matter of any of the Examples MMM1-MMM7 can optionally include where the vehicle assist drone housing can recharge a battery in the vehicle assist drone when the vehicle assist drone is coupled to the vehicle assist drone housing.

In Example, MMM20, the subject matter of any of the Examples MMM1-MMM8 can optionally include where the battery is recharged wirelessly.

In Example, MMM21, the subject matter of any of the Examples MMM1-MMM9 can optionally include where the vehicle assist drone is an autonomous drone that autonomously collects the sensor data related to an environment around the vehicle.

In Example, MMM22, the subject matter of any of the Examples MMM1-MMM10 can optionally include where the vehicle controls navigation and sensor data collection of the vehicle assist drone.

In Example, MMM23, the subject matter of any of the Examples MMM1-MMM11 can optionally include where the vehicle assist drone is an aerial drone.

In Example, MMM24, the subject matter of any of the Examples MMM1-MMM12 can optionally include where the vehicle is an autonomous vehicle.

What is claimed is:

1. A method for guiding a user of an AV service to a vehicle associated with the AV service, the method comprising:
deploying a vehicle assist drone to a location of the user of the AV service; and
providing an indicator to guide to the user of the AV service to the vehicle.

2. The method of claim 1, wherein the indicator is an arrow or line.

3. The method of claim 1, wherein the indicator is a sound.

4. The method of claim 1, wherein the vehicle includes a vehicle assist drone housing and the vehicle assist drone housing can recharge a battery in the vehicle assist drone when the vehicle assist drone is coupled to the vehicle assist drone housing.

5. The method of claim 1, wherein the vehicle assist drone authenticates the user through communication with a user device associated with the user.

6. The method of claim 1, wherein the vehicle assist drone is an aerial drone.

7. The method of claim 6, wherein the indicator is an arrow or line that is projected on the ground by the vehicle assist drone.

8. The method of claim 1, wherein the vehicle is an autonomous vehicle.

9. The method of claim 1, wherein the vehicle assist drone is an autonomous drone that navigates without navigation instructions from the vehicle.

10. A method for clearing one or more occlusions in an environment around a vehicle, the method comprising:
deploying a vehicle assist drone from the vehicle, wherein the vehicle assist drone includes one or more sensors and is in communication with the vehicle;
causing the one or more sensors on the vehicle assist drone to collect sensor data related to the environment around the vehicle; and
receiving the collected sensor data from the vehicle assist drone, wherein the collected sensor data is used to clear one or more occlusions in the environment around the vehicle.

11. The method of claim 10, wherein the vehicle assist drone is an autonomous drone that autonomously collects the sensor data related to the environment around the vehicle.

12. The method of claim 10, wherein the vehicle controls navigation and sensor data collection of the vehicle assist drone.

13. The method of claim 10, further comprising:
collecting sensor data related to a route of the vehicle using the one or more sensors on the vehicle assist drone; and
analyzing the collected sensor data to identify one or more obstructions along the route.

14. The method of claim 13, further comprising:
creating a new route for the vehicle based on the identified one or more obstructions along the route.

15. A vehicle assist drone for supplementing vehicle sensor data of a vehicle with supplemental sensor data from one or more sensors on the vehicle assist drone, the vehicle assist drone comprising:
a main body;
a propulsion assembly;
a sensor suite including one or more sensors to sense an environment and generate sensor data;
a perception system to receive the sensor data and to acquire map data and to use the map data and the sensor data to generate vehicle assist drone real world environment data; and
a vehicle interface module to communicate with the vehicle.

16. The vehicle assist drone of claim 15, further comprising:
a user guidance module to provide an indicator to guide to a user of an AV service to the vehicle.

17. The vehicle assist drone of claim 15, wherein the vehicle assist drone real world environment data is used to clear one or more occlusions in sensor data of the vehicle related to the environment around the vehicle.

18. The vehicle assist drone of claim 15, wherein the one or more sensors include a camera, a light detection and ranging sensor, and/or a time-of-flight sensor.

19. The vehicle assist drone of claim 15, wherein the vehicle assist drone real world environment data is used to identify upcoming obstacles along a route of the vehicle.

20. The vehicle assist drone of claim 19, wherein a new route of the vehicle is determined based on identification of upcoming obstacles along the route of the vehicle.
